(19) United States
(12) Patent Application Publication
(10) Pub. No.: US 2024/0390222 A1
(43) Pub. Date: Nov. 28, 2024

(54) RECIPROCATING DRIVE MECHANISM OF CONTINUOUSLY VARIABLE AMPLITUDE AND FASCIA GUN WITH THE SAME

(71) Applicant: SICHUAN QIANLI-BEOKA MEDICAL TECHNOLOGY INC., Chengdu (CN)

(72) Inventors: Changlong LEI, Chengdu (CN); Wen ZHANG, Chengdu (CN)

(21) Appl. No.: 18/790,754

(22) Filed: Jul. 31, 2024

Related U.S. Application Data
(63) Continuation-in-part of application No. PCT/CN2023/109742, filed on Jul. 28, 2023.

(30) Foreign Application Priority Data
Mar. 22, 2023 (CN) CN202310288298.X
Aug. 25, 2023 (CN) CN202322300194.4
Aug. 30, 2023 (CN) CN202322348999.6
Aug. 31, 2023 (CN) CN202322352307.5
Aug. 31, 2023 (CN) CN202322352308.X
Aug. 31, 2023 (CN) CN202322352310.7
Sep. 1, 2023 (CN) CN202322375272.7
Sep. 1, 2023 (CN) CN202322375567.4
Sep. 4, 2023 (CN) CN202322383491.X
Sep. 4, 2023 (CN) CN202322384161.2
Sep. 7, 2023 (CN) CN202322429532.4
Sep. 7, 2023 (CN) CN202322429535.8
Sep. 7, 2023 (CN) CN202322429545.1
Sep. 13, 2023 (CN) CN202322489245.2
Sep. 13, 2023 (CN) CN202322489256.0
Sep. 13, 2023 (CN) CN202322491109.7
Sep. 21, 2023 (CN) CN202322570295.3
Sep. 25, 2023 (CN) CN202311241181.2
Sep. 25, 2023 (CN) CN202311241241.0
Sep. 25, 2023 (CN) CN202311241250.X
Sep. 25, 2023 (CN) CN202311241288.7
Sep. 25, 2023 (CN) CN202311241408.3
Sep. 25, 2023 (CN) CN202311241454.3
Sep. 25, 2023 (CN) CN202311241583.2
Sep. 25, 2023 (CN) CN202311246711.2
Sep. 25, 2023 (CN) CN202311246993.6
Sep. 25, 2023 (CN) CN202322600378.2
Sep. 25, 2023 (CN) CN202322600420.0
Sep. 25, 2023 (CN) CN202322603455.X
Oct. 18, 2023 (CN) CN202311357628.2
Oct. 18, 2023 (CN) CN202311358102.6
Oct. 18, 2023 (CN) CN202322789224.2
Oct. 30, 2023 (CN) CN202322920530.5
Oct. 30, 2023 (CN) CN202322921252.5
Oct. 30, 2023 (CN) CN202322922702.2
Nov. 21, 2023 (CN) CN202323492527.4
Nov. 21, 2023 (CN) CN202323508289.1
Nov. 21, 2023 (CN) CN202323508329.2
Nov. 22, 2023 (CN) CN202311562836.6
Jun. 24, 2024 (CN) CN202421447845.0

(51) Int. Cl. A61H 23/02

(52) U.S. Cl. CPC A61H 23/0263; A61H 2201/0153; A61H 2201/0157; A61H 2201/1215; A61H 2201/1409; A61H 2201/1436; A61H 2201/149; A61H 2201/1664

(57) ABSTRACT

Aspects relate to fascia guns, and in particular, to reciprocating drive mechanisms of continuously variable amplitude with simple and reliable structure. The mechanism includes a slider-crank mechanism composed of a crank, an output rod, a connecting rod and a slider that are hinged in sequence, and further includes a swing adjusting mechanism, where a hinge point between the output rod and the connecting rod is a swing hinge point, and the swing adjusting mechanism is configured to adjust and define the swinging range of the swing hinge point. In examples when the amplitude of a piston is adjusted, an eccentric distance of an eccentric wheel has no any change. Therefore, the key to adjust the amplitude of the piston is to adjust the swinging amplitude of the swing hinge point of the output rod. The invention is especially suitable for being widely used on fascia gun products.

### CROSS-REFERENCE TO RELATED APPLICATIONS

This Bypass Continuation-in-Part application claims priority under 35 U.S.C. § 120 from PCT/CN2023/109742, filed on Jul. 28, 2023, entitled STEPLESS AMPLITUDE-CHANGE RECIPROCATING DRIVE MECHANISM AND FASCIA GUN, which claims priority to Chinese Patent Application No. CN202310288298.X, filed on Mar. 22, 2023. This Bypass Continuation-in-Part Application also claims priority to each of the following Chinese patent applications individually: CN202421447845.0, filed on Jun. 24, 2024, CN202311562836.6, filed on Nov. 22, 2023, CN202323492527.4, filed on Nov. 21, 2023, CN202323508329.2, filed on Nov. 21, 2023, CN202323508289.1, filed on Nov. 21, 2023, CN202322921252.5, filed on Oct. 30, 2023, CN202322922702.2, filed on Oct. 30, 2023, CN202322920530.5, filed on Oct. 30, 2023, CN202311358102.6, filed on Oct. 18, 2023, CN202311357628.2, filed on Oct. 18, 2023, CN202322789224.2, filed on Oct. 18, 2023, CN202322600378.2, filed on Sep. 25, 2023, CN202322600420.0, filed on Sep. 25, 2023, CN202311241408.3, filed on Sep. 25, 2023, CN202311241250.X, filed on Sep. 25, 2023, CN202311241181.2, filed on Sep. 25, 2023, CN202311241241.0, filed on Sep. 25, 2023, CN202311241583.2, filed on Sep. 25, 2023, CN 202311246993.6, filed on Sep. 25, 2023, CN202311241288.7, filed on Sep. 25, 2023, CN202311246711.2, filed on Sep. 25, 2023, CN202322603455.X, filed on Sep. 25, 2023, CN202311241454.3, filed on Sep. 25, 2023, CN202322570295.3, filed on Sep. 21, 2023, CN202322489256.0, filed on Sep. 13, 2023, CN202322489245.2, filed on Sep. 13, 2023, CN202322491109.7, filed on Sep. 13, 2023, CN202322429535.8, filed on Sep. 7, 2023, CN202322429532.4, filed on Sep. 7, 2023, CN202322429545.1, filed on Sep. 7, 2023, CN202322383491.X, filed on Sep. 4, 2023, CN202322384161.2, filed on Sep. 4, 2023, CN202322375567.4, filed on Sep. 1, 2023, CN202322375272.7, filed on Sep. 1, 2023, CN202322352310.7, filed on Aug. 31, 2023, CN202322352307.5, filed on Aug. 31, 2023, CN202322352308.X, filed on Aug. 31, 2023, CN202322348999.6, filed on Aug. 30, 2023, and CN202322300194.4, filed on Aug. 25, 2023. The disclosures of all above-referenced applications are incorporated by reference herein in their entireties.

### TECHNICAL FIELD

The invention relates to the field of fascia guns, and in particular, to a reciprocating drive mechanism of continuously variable amplitude and a fascia gun with the same.

### BACKGROUND

A fascia gun, also known as a deep muscle fascia impactor, is a soft tissue massage tool that is used to relax the soft tissue of the human body through high-frequency impact. Existing fascia guns drive massage heads to perform linear reciprocating motion through pistons, the massage heads contact with the human body to generate high-frequency vibration acting on the deep muscles, so as to reduce local tissue tension, relieve pain and promote blood circulation. The existing fascia guns have achieved the function of the amplitude adjustment of the massage head, by which users can choose the appropriate amplitude depth of the fascia gun for massage physiotherapy according to their own situations. For example, professional athletes need to use fascia guns with deep amplitude depth to relieve post-exercise muscles. Ordinary consumers, especially novices, need to use fascia guns with shallow amplitude depth at the beginning, and then gradually use those with deep amplitude depth as needed.

In the existing fascia guns with adjustable amplitude depth, the adjustment principle thereof is to design a mechanism that can directly adjust the eccentric distance, and then adjust the distance between the output shaft of the motor and the output shaft of the eccentric wheel, so as to adjust the vibration amplitude of the piston. Patent application CN115444733A is taken as an example, this solution relates to the field of massage devices, and in particular, to a fascia gun with variable amplitude, where the amplitude of the fascia gun can be achieved by switching the forward and reverse rotation states of a motor. The fascia gun includes the motor, an eccentric distance adjusting member with an eccentric shaft, a connecting rod and a piston rod, one end of the connecting rod is rotatably connected with the eccentric shaft, and the other end of the connecting rod is rotatably connected with the piston rod; the eccentric distance adjusting member includes a sliding skew block and an eccentric slider structure with the eccentric shaft, and the output shaft of the motor is in threaded transmission connection with the sliding skew block, and the sliding skew block slides onto the eccentric slider structure under the drive of the motor and pushes the eccentric slider structure to move in a direction perpendicular to the output shaft of the motor. In this solution, the eccentric distance is directly adjusted by changing the position of the sliding skew block, so as to adjust the amplitude of the piston. The eccentric distance needs to be directly adjusted by such an adjustment method, the structure is relatively complex, and the stability cannot be ensured after the amplitude is adjusted.

### SUMMARY OF THE INVENTION

A technical problem to be solved by the invention is to provide a reciprocating drive mechanism of continuously variable amplitude with a simple and reliable structure, and a fascia gun with the same.

The technical solution adopted by the invention to solve the technical problems is that: a reciprocating drive mechanism of continuously variable amplitude comprises a slider-crank mechanism composed of a crank, an output rod, a connecting rod and a slider that are hinged in sequence, and a swing adjusting mechanism, where a hinge point between the output rod and the connecting rod is a swing hinge point, and the swing adjusting mechanism is configured to adjust and define the swinging range of the swing hinge point. When the mechanism actually moves, the output rod swings back and forth with the rotation of the crank, and the output rod drives the connecting rod and then drives the slider to move back and forth. In this case, if the reciprocating swinging amplitude and swinging range of the hinge point (namely, the swing hinge point) between the output rod and the connecting rod is adjusted, and then defined the reciprocating swing amplitude and swing range of the swing hinge point after adjustment, a new reciprocating amplitude of the slider will be obtained, so as to adjust the amplitude of the slider. In this solution, the reciprocating amplitude of the slider is continuously adjusted through such simple and ingenious structural design. Compared with existing continuous adjustment methods, such continuous adjustment effectively can reduce the structural complexity and manufacturing cost, and help the users to perform adjustment.

As a preferred structural form of the swing adjusting mechanism, the following solution is preferred: the swing adjusting mechanism includes an adjusting rod with a swinging end and an adjusting end; the swinging end of the adjusting rod is hinged on the output rod, and the hinged position of the adjusting end of the adjusting rod is adjustable. In actual use, since the swinging end of the adjusting rod is rotatably connected to the output rod, the adjusting rod moves with the swing of the output rod. When the amplitude of the slider needs to be adjusted, the rotating connection position of the adjusting end of the adjusting rod is adjusted to change the swinging range of the swing hinge point, and the amplitude of the slider is adjusted accordingly. This solution features in simple structural design, but effectively achieves the adjustment effect of the amplitude of the slider.

In practical application, the above structure can be selected as the following specific structural form: the crank is an eccentric wheel, the connecting rod is a swinging arm, and the slider is a piston, a connecting line between the rotating connecting end of the output rod and the swinging arm and the rotating input end of the eccentric wheel is a first cycloid, and a connecting line between the adjusting end of the adjusting rod and the rotating input end of the eccentric wheel is a second cycloid; an included angle between the first cycloid and the reciprocating axis of the piston is a first included angle θ, and an included angle between the second cycloid and the reciprocating axis of the piston is a second included angle β; and the second included angle β is adjusted so that the swinging range of the first included angle θ is adjusted in linkage. The second included angle β is adjusted to change the swing trajectory of the output rod, which will inevitably lead to the change in the swinging range of the swing hinge point of the output rod and further achieves the adjustment of piston amplitude. The first cycloid is corresponding to a connecting line od in FIG. 16, the second cycloid is corresponding to a connecting line o-g in FIG. 16, and a horizontal line in FIG. 16 is a piston reciprocating axis. In the above structure, the reciprocating amplitude of the piston satisfies the following relationship: F=L1*|Cos θmax−Cos θmin|; where F represents the reciprocating amplitude of the piston; L1 represents the length of the first cycloid; θmax represents the maximum swing angle of the first cycloid with respect to the second included angle β; and θmin represents the minimum swing angle of the first cycloid with respect to the second included angle β. Preferably, the second included angle β ranges from −20° to 30°, and the swing angle of the first included angle θ ranges from −20° to 90°. In order to prevent rotation failure due to jamming, the value of 0 does not include 90°. The linkage change of the swinging range of the first included angle θ, caused by adjusting the second included angle β, can be accurately calculated through the above structure, and then the reciprocating amplitude can be calculated. This provides a structural basis for the implementation of the reciprocating drive mechanism of continuously variable amplitude to specific products, so that the continuous adjustment process of the amplitude can be accurately controlled.

In order to simplify the structure and achieve smooth transmission, the invention can adopt the following solution that: includes an output hinge point between the output rod and the crank, an adjusting hinge point between the output rod and the swinging end of the adjusting rod, and a projection plane perpendicular to the rotating input end of the eccentric wheel, where the output hinge point, the adjusting hinge point and the swing hinge point are all projected onto the projection plane to obtain corresponding projection points, and the included angle of the connecting lines between any two projection points ranges from 0° to 360°. In actual design, the shape of the output rod is diversified. The structure of the output rod, defined by the above projection relationship, can be a rod extending along a straight line, a bent rod, a disk or the like. In addition to a planar structure, a three-dimensional structure with a convex or concave structure at any hinge point can also be used as the output rod when the above projection relationship is satisfied. Meanwhile, the adjusting hinge point between the output rod and the swinging end of the adjusting rod can also extend in two opposite directions from the swing hinge point. However, regardless of any specific shape, as long as the included angle of the connecting lines between the projections of any two hinge points is within the range of 0°-360°, the formed motion mechanism can be ensured to achieve the corresponding swing action and the transmission of the reciprocating action, and adjust the reciprocating amplitude. The included angle of the connecting lines does not include two endpoint values of 0° and 360°.

In order to adjust the position of the adjusting end of the adjusting rod in real time, a position adjusting mechanism can be selected, the adjusting end of the adjusting rod is hinged on the position adjusting mechanism, and the position adjusting mechanism drives the adjusting end of the adjusting rod to move in relation to a position. The position of the adjusting end of the adjusting rod can be adjusted conveniently and reliably through the position adjusting mechanism, so that the adjusting rod is driven to adjust the swinging range of the swing hinge point of the output rod, and the amplitude of the slider is adjusted.

As a specific embodiment of the position adjusting mechanism, the position adjusting mechanism includes a lead screw and a lead screw nut, and the lead screw nut is rotatably arranged on the adjusting end of the adjusting rod, the lead screw is connected with a driving unit, and the driving unit drives the lead screw to rotate, whereby driving the lead screw nut to axially slide along the lead screw. Specifically, the driving unit drives the lead screw to rotate, and then drives the lead screw nut to slide along the extension direction of the lead screw, thus changing the position of the adjusting end of the adjusting rod. This not only makes the whole adjustment process very convenient and accurate, but also provides a structural basis for being subsequently productized. Preferably, the driving unit is a driving motor or a manual knob, so as to achieve a more reasonable driving mode, optimize product cost, and provide support for product diversification.

As another specific embodiment of the position adjusting mechanism, the position adjusting mechanism may be a limit chute, the adjusting end of the adjusting rod is hinged with a slider slidably arranged in the limit chute, a slider fixing mechanism for fixing the slider to the limit chute is arranged on the slider, the slider fixing mechanism is a threaded knob and a fastening block in threaded fit with the threaded knob, and the slider is fixedly arranged on the limit chute when the threaded knob is tightened. The slider is limited to slide in the limit chute, and the position of the adjusting end of the adjusting rod is also adjusted in a slider sliding process. When the slider needs to be fixed at a specified position in the limit chute, only the threaded knob needs to be tightened, and the slider is fixedly arranged in the limit chute through the threaded knob, so that the position of the slider can be fixed and the required amplitude range of the piston can be obtained.

As another preferred structural form of the swing adjusting mechanism, the swing adjusting mechanism includes a limit baffle, the swinging range of the swing hinge point is set within the swinging range of the limit baffle, and the swinging range of the limit baffle is adjustable. The limit baffles form a relative swinging range, and the whole motion trajectory of the swing hinge point is limited within the swinging range. When necessary, only the swinging range of the limit baffle can be adjusted to obtain a new swinging range of the swing hinge point and adjust the amplitude of the slider.

As a further preferred embodiment of the above solution, preferably, the limit baffle has two baffles, the swing hinge point is arranged between the two baffles, and the distance between the two baffles is adjustable. The two baffles form a relative swinging range, and the swing hinge point is limited to move within the swinging range. When necessary, the swinging range of the swing hinge point can be adjusted only by adjusting the distance between the two baffles or the positions of the two baffles, and then the amplitude of the slider can be adjusted. In this solution, the positions of the baffles are flexibly arranged according to the actual arrangement needs, thereby saving the corresponding arrangement space. In addition, the swinging range of the limit baffle is directly adjusted to obtain the large swing adjustment range of the swing hinge point and further obtain the large amplitude adjustment range of the slider.

Based on the reciprocating drive mechanism of continuously variable amplitude, a corresponding fascia gun can also be obtained. The fascia gun includes a mounting chamber composed of a lower shell, an upper shell, a front cover and a rear cover, and a motor for driving a crank to rotate, and the slider is a piston slidably arranged in the piston hole of the front cover. In actual use, when the users need to adjust the vibration amplitude of the piston of the fascia gun, only the swing adjusting mechanism can be simply adjusted to conveniently adjust the swinging amplitude and swinging range of the output rod, so that the adjustment demand can be achieved. The fascia gun obtained based on the above reciprocating drive mechanism of continuously variable amplitude is greatly simplified in the structure of the amplitude adjustment system, and easy to achieve at the product level and popularize on a large scale in a later stage. In addition, the structure also makes the users adjust the amplitude more conveniently and accurately, which greatly improves the user experience.

As a further optimization of the above solution, preferably, the crank is an eccentric wheel, and the rotating input end of the eccentric wheel is fixedly connected with the output shaft of the motor. The eccentric wheel of the fascia gun is combined with the motor of the fascia gun, in a case that the eccentric distance of the eccentric wheel is not adjusted, the amplitude of the piston can be adjusted through the reciprocating drive mechanism of continuously variable amplitude.

In order to facilitate the mounting and fixation of the swing adjusting mechanism, a motor fixing stand can be optionally added, and the motor and the swing adjusting mechanism are arranged on the motor fixing stand. As a mechanism for adjusting the swinging amplitude and swinging range of the output rod, the swing adjusting mechanism will be subjected to high-frequency counter-acting force in an actual motion process. Therefore, the stability of the position of the swing adjusting mechanism is a design point that needs to be considered in an actual product. In view of the limited internal arrangement space of fascia gun products, the swing adjusting mechanism is arranged on the motor fixing stand, which makes good use of the stand originally used for fixing the motor, further saves the arrangement space and makes the internal arrangement more reasonable. In order to achieve the above stable arrangement, a mounting hole can be arranged on the swing adjusting mechanism, and the swing adjusting mechanism is arranged on the motor fixing stand through the mounting hole.

The invention has the beneficial effect that the existing fascia gun can achieve the effect of adjustable amplitude by directly adjusting the eccentric distance of the fascia gun, namely, increasing or decreasing the eccentric distance. The structural design is difficult to achieve in actual products. Adjustable eccentric distance brings the problems such as increased wear and vibration of related components, decreased stability of the overall structure, and high product production and manufacturing cost. Meanwhile, the relative position needs to be adjusted by changing the eccentric distance between the swinging arm and the eccentric wheel, if the relative position is changed in operation, the stability of the mechanism subjected to amplitude adjustment cannot be guaranteed, that is, it is difficult to guarantee the stability of the mechanism subjected to amplitude adjustment in actual use.

According to the invention, when the amplitude of a piston is adjusted, an eccentric distance of an eccentric wheel has no any change, therefore, the key to adjust the amplitude of the piston is to adjust the swinging amplitude of the swing hinge point of the output rod. Specifically, the output rod swings back and forth with the rotation of the eccentric wheel, and the change in the swinging amplitude and swinging range of the swing hinge point of the output rod will be transmitted to the piston through the swinging arm, which eventually leads to the change in the reciprocating amplitude of the piston. The additional swing adjusting mechanism is configured to directly control and adjust the swinging range of the swing hinge point, so as to directly and effectively adjust the reciprocating motion trajectory of the piston. Because the swinging amplitude of the swing hinge point and the swinging range thereof are adjusted, the internal relative connection will not cause the change in relative position in an adjustment process, and the operation stability of the mechanism subjected to amplitude adjustment is better. The invention is especially suitable for being widely used on fascia gun products.

### BRIEF DESCRIPTION OF DRAWINGS

FIG. 1 is a schematic diagram showing mechanical motion of a reciprocating drive mechanism of continuously variable amplitude.

FIG. 2 is a schematic diagram showing adjustment of a swinging range of a swing hinge point d of a reciprocating drive mechanism of continuously variable amplitude through an adjusting rod.

FIG. 3 is a schematic diagram showing definition of a swinging range of a swing hinge point d of a reciprocating drive mechanism of continuously variable amplitude by baffles at upper and lower sides.

FIG. 4 is a schematic diagram showing a maximum amplitude range of a corresponding piston when an adjusting rod of the invention is arranged at a bottom end of a limit chute.

FIG. 5 is a schematic diagram showing a minimum amplitude range of a corresponding piston when an adjusting rod of the invention is arranged at a top end of a limit chute.

FIG. 6 is a schematic diagram showing a piston at a maximum stroke position in a case that an adjusting rod of the invention is arranged at a position where the piston has a maximum amplitude range.

FIG. 7 is a schematic diagram showing a piston at a minimum stroke position in a case that an adjusting rod of the invention is arranged at a position where the piston has a maximum amplitude range.

FIG. 8 is a schematic diagram showing a piston at a maximum stroke position in a case that an adjusting rod of the invention is arranged at a position where the piston has a minimum amplitude range.

FIG. 9 is a schematic diagram showing a piston at a minimum stroke position in a case that an adjusting rod of the invention is arranged at a position where the piston has a minimum amplitude range.

FIG. 10 is a schematic diagram showing a piston at a maximum stroke position in a case that an adjusting rod of the invention is arranged at a position where the amplitude range of the piston is between the maximum amplitude range and the minimum amplitude range.

FIG. 11 is a schematic diagram showing a piston at a minimum stroke position in a case that an adjusting rod of the invention is arranged at a position where the amplitude range of the piston is between the maximum amplitude range and the minimum amplitude range.

FIG. 12 is a schematic diagram showing an adjusting rod of the invention being arranged at one of swing limit positions.

FIG. 13 is a schematic diagram showing the adjusting rod in FIG. 12 being swung to another of swing limit positions.

FIG. 14 is a schematic diagram of a piston amplitude calculation method.

FIG. 15 is a schematic diagram showing a position adjusting mechanism of a reciprocating drive mechanism of continuously variable amplitude being a lead screw and a lead screw nut.

FIG. 16 is a schematic diagram showing a change relationship between adjustment angles of a reciprocating drive mechanism of continuously variable amplitude in an embodiment.

FIG. 17 is an exploded view showing disassembled main components of a fascia gun according to the invention.

FIG. 18 is an exploded view showing a reciprocating drive mechanism of continuously variable amplitude according to the invention and surrounding components being disassembled.

FIG. 19 is a structural schematic diagram showing an embodiment of a reciprocating drive mechanism of continuously variable amplitude according to the invention.

FIG. 20 is a structural schematic diagram showing a limit chute of a reciprocating drive mechanism of continuously variable amplitude according to the invention.

FIG. 21 is a schematic diagram showing an embodiment of amplitude adjustment by changing a lever fulcrum.

FIG. 22 is a schematic diagram showing an embodiment of amplitude adjustment by triggering a controller signal.

FIG. 23 is a schematic diagram showing an embodiment of accurate amplitude adjustment through a touch screen.

FIG. 24 is a schematic diagram showing an embodiment of amplitude adjustment by manually turning a knob switch.

FIG. 25 is a schematic diagram showing an embodiment of amplitude adjustment by changing eccentric distance via pressing.

FIG. 26 is a schematic diagram showing an embodiment of amplitude adjustment by changing eccentric distance through gear transmission.

FIG. 27 is a schematic diagram showing an embodiment of amplitude adjustment by changing an eccentric distance through a lever.

FIG. 27A is a schematic diagram showing FIG. 27 being in a state of eccentric distance e271 after assembly.

FIG. 27B is a schematic diagram showing FIG. 27 being in a state of eccentric distance e272 after assembly.

FIG. 28 is a schematic diagram showing an embodiment of amplitude adjustment by changing eccentric distance through electric adjustment.

FIG. 28A is an oblique view of FIG. 28.

FIG. 29 is a schematic diagram showing another embodiment of amplitude adjustment by changing eccentric distance through electric adjustment.

FIG. 30 is a schematic diagram showing an embodiment of amplitude adjustment by changing eccentric distance through eccentric distance adjustment.

FIG. 30A is a top view showing a planet wheel being in an unlocking state.

FIG. 30B is a lateral view showing a planet wheel being in an unlocking state.

FIG. 30C is a top view showing a planet wheel being in a locking state.

FIG. 30D is a lateral view showing a planet wheel being in a locking state.

FIG. 31 is a schematic diagram showing an embodiment of amplitude adjustment by changing eccentric distance through a knob.

FIG. 32 is a schematic diagram showing an embodiment of amplitude adjustment through forward rotation and reverse rotation of a motor.

FIG. 33 is a schematic diagram showing mechanical motion of a reciprocating drive mechanism of continuously variable amplitude.

FIG. 34 is a schematic diagram showing an embodiment of a mechanical motion principle shown in FIG. 33.

FIG. 35 is a structural schematic diagram showing amplitude adjustment through included angle adjustment.

FIG. 36 is a function relationship diagram showing an offset distance and amplitude of an amplitude adjusting structure shown in FIG. 35.

FIG. 37 is a schematic diagram showing an embodiment of an adjusting mechanism that makes full use of three-dimensional space for amplitude adjustment.

FIG. 38 is a structural schematic diagram showing amplitude adjustment by pressing an adjusting structure.

FIG. 38A is a schematic diagram showing an application of the adjusting structure shown in FIG. 38 to a fascia gun.

FIG. 38B is a schematic diagram showing a spiral gear and a rotor slider.

FIG. 39 is a structural schematic diagram showing amplitude adjustment of a gear ring knob structure.

FIG. 40 is a structural schematic diagram showing manual amplitude adjustment of a gear ring knob.

FIG. 40A is a schematic diagram showing FIG. 40 after assembly.

FIG. 41 is a structural schematic diagram showing amplitude adjustment through a torsional spring.

FIG. 41A is a structural schematic diagram showing removal of a display board in FIG. 41.

FIG. 42 is a structural schematic diagram showing amplitude adjustment through a manual knob and a rack.

FIG. 43 is a structural schematic diagram showing amplitude adjustment by adjusting a mechanical knob.

FIG. 43A is a schematic diagram showing a structural relationship of a rotating knob and a linkage rod in FIG. 43.

FIG. 44 is a schematic diagram showing a connection structure of two ends of an adjusting rod.

FIG. 45 is a structural schematic diagram showing correction of an amplitude adjustment error by a magnetic sensor.

FIG. 46 is a schematic diagram showing amplitude adjustment by adjusting a length of an adjusting rod.

FIG. 47 is a schematic diagram showing amplitude adjustment by driving a cylindrical cam to rotate through a motor.

FIG. 48 is a structural schematic diagram showing an improvement in a massage effect through quick-return characteristics.

FIG. 49 is a schematic diagram showing a change curve between an ordinate of a fifth hinge point and amplitude of a slider according to the invention.

FIG. 50 is a schematic diagram showing comparison of massage paths parallel (a) and perpendicular (b) to muscle fibers.

FIG. 51 is a process diagram showing amplitude adjustment according to a change in a speed of a driving motor of a massage head.

FIG. 52 is a process diagram showing amplitude adjustment according to muscle types.

FIG. 53 is a schematic diagram showing an automatic amplitude adjustment method based on massage head recognition.

FIG. 54 is a schematic diagram showing an amplitude adjustment method based on an office scenario.

FIG. 55 is a schematic diagram showing an amplitude adjustment method based on a relaxation scenario after running.

FIG. 56 is a schematic diagram showing an amplitude adjustment method based on electromyographic signals.

FIG. 57 is a schematic diagram showing an embodiment of amplitude adjustment based on muscle oxygen saturation.

FIG. 58 is a schematic diagram showing a dynamic amplitude adjustment method based on biometric information.

FIG. 59 is a schematic diagram showing a dynamic amplitude adjustment method with body fat detection.

FIG. 60 is a process diagram showing matching of different amplitudes according to different speeds.

Symbols are as follows: upper shell 1, reciprocating drive mechanism 2, front cover 3, lower shell 4, handle 5, rear cover 6, connecting rod 7, bearing 8, output rod 9, crank 91, limit baffle 92, slider 10, piston 101, adjusting rod 11, slider 12, threaded knob 13, fastening block 14, limit chute 15, eccentric wheel 16, motor fixing stand 17, motor 18, slider position 111 at a minimum piston amplitude range, slider position 112 at a maximum piston amplitude range, third slider position 113, first limit swing position f1 of output rod, second limit swing position f2 of output rod, piston amplitude range f, power source a, output hinge point c, swing hinge point d, adjusting hinge point e, rotation point g between adjusting rod and slider, lead screw 151, lead screw nut 152, driving unit 153, first cycloid length L1, first included angle θ, second included angle β, first spacing A, second spacing B, support arm 701, adjusting chute 702, touch screen 232, MCU 2310, driving module 2311, motor 238, amplitude adjusting mechanism 239, massage head 24300, knob switch 24500, encoder switch 24700, main board 24600, eccentric sleeve 2542, rotating retaining ring 2533, fixing spring 2531, pressing rod 2529, steel wire retaining ring 2527, adjusting wheel 26121, accommodating groove 2711, yielding hole 2751, second rotating shaft 2742, adjusting rod 274, adjusting slider 275, cylindrical pin 2752, eccentric distance e271, eccentric distance e272, second guide groove 286, slider 2874, guide block 2875, lead screw 2873, first guide groove 285, output shaft 29100 of motor, driving member 2960, connecting member 2950, electric brush 2912, cover plate hole 3061, cover plate 306, internal gear knob 307, inserting rod 3041, rotating rod 3042, shifting rod 3043, limit block 3046, inserting rod chute 3047, planet wheel output shaft 3051, planet wheel 305, planet wheel input shaft 3052, eccentric wheel output hole 3048, adapter sleeve 31114, rotating sleeve 31103, drive sleeve 3195, driving rod 3164, eccentric ring 3158, steel wire retaining ring 3156, eccentric output shaft 31201, rotating shaft 3230, rotating bearing 3220, threaded hole 32101, locking screw 32103, limit plate 32120, supporting suction part 32506, electromagnet 32507, controller 32508, first output rod 3391, second output rod 3392, chute 3311 in adjusting end of adjusting rod, swing adjusting mechanism 3460, mounting housing 3461 of swing adjusting mechanism, threaded rotating rod 3462, gear set 3465, slider guiding element 355, locking mechanism 356, crank fastener 354, offset distance e35, back cover 3710, guide rail 3720, lifting block 3731, lead screw 3732, moving block 3733, spherical hinge 3711, inner rotating disk 3818, first rack 3815, outer gear ring 3817, rotor slider 384, screw 3820, spiral gear 385, second rack 3816, second driving shaft 3813, second one-way driving gear 3822, second connecting hole 3811, shaft sleeve 389, cylindrical rack 386, first connecting hole 3810, first driving shaft 3812, limit chute 3824, limit chamber 3823, driven bevel gear 3914, driving bevel gear 3915, driving gear 3916, internal gear ring 3917, lead screw 3913, knob 394, fixed disk 402, driving gear 4015, rotating cover 401, fixed cover 4014, driven gear 405, transmission rod 403, second transmission gear 404, chute 406, lead screw 407, fixing holder 4110, lead screw 4131, guide rail 4111, inserting hole 4112, blocking rod 4151, pressure sensor 4121, indicator 4161, rotating plate 4140, stress plate 4141, gear scale value 4163, communication groove 4162, display plate 4160, torsion spring 4170, driving motor 4132, chute I 4221, slide carriage 4220, clamping groove 4222, rack 4236, gear ring 4235, snap ring 4234, retaining ring 4233, rotating shaft 4231, knob I 4232, threaded hole 4237, threaded rod 4238, knob II 4239, spring base 439, driving rod 43731, linkage rod 438, groove 4381, rotating knob lug boss 43721, rotating knob 4372, convex groove 43711, inner cover lug boss 43712, rotating rod 4373, base rod 43732, bending connecting part 43733, inner cover of knob 4371, threaded head end 4363, linkage groove 4382, linkage groove end part 43821, guide rod 43822, linkage groove 4382, guide wheel 4383, through hole 4431, baffle 4465, clamping groove 4465, fixing shaft 4461, locking groove 4471, first guide surface 4468, clamping block 4464, vertical surface 4470, locking block 4462, spring 4463, guide groove 4467, first guide surface 4468, second guide surface 4469, detection circuit board 4551, magnetic sensor 455, magnetic member 4522, adjusting motor 4531, reduction gear 4532, inserting hole 4614, rotating rod 4634, baffle 4623, stress block 4624, second rod body 4632, rotating ring 4637, guide rod 4633, first rod body 4631, output member 47130, output member body 47131, elastic thimble 47132, mounting chamber 47130A, transmission member 47120, turning disc 47121, first connector 47122, connecting member 47121A, driving surface 47121B, second connector 47150, adjusting element 4742, blocking element 47421, force transmission member 47422, force application element 47423, output shaft 471, driving member 470, motor 4711, turbine 4712, worm 4713, crank 481, connecting rod 482, rocker 483, frame rod 484, sliding rod 485, sliding rail 486, adjusting block 487, first chute 489, connecting column 4810, fixing part 4811, sliding part 4812, slider 4813, physiological parameter collecting device 57150, control system 57140.

### DESCRIPTION OF EMBODIMENTS

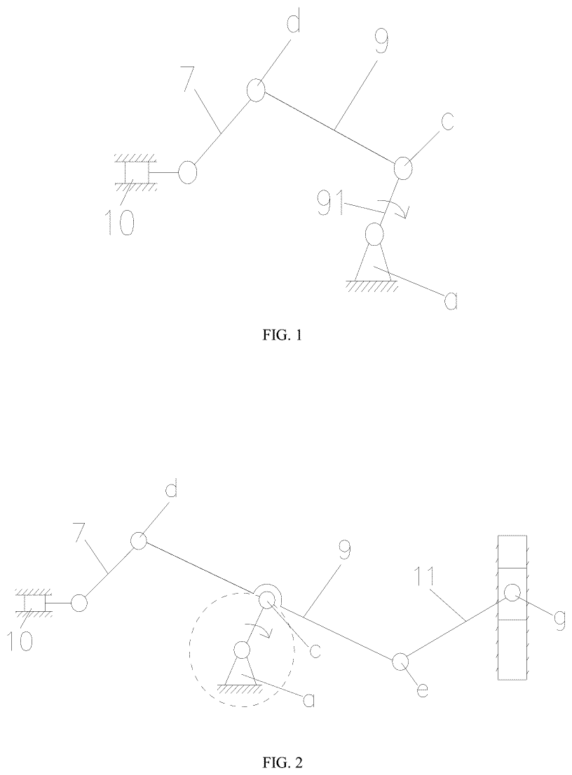

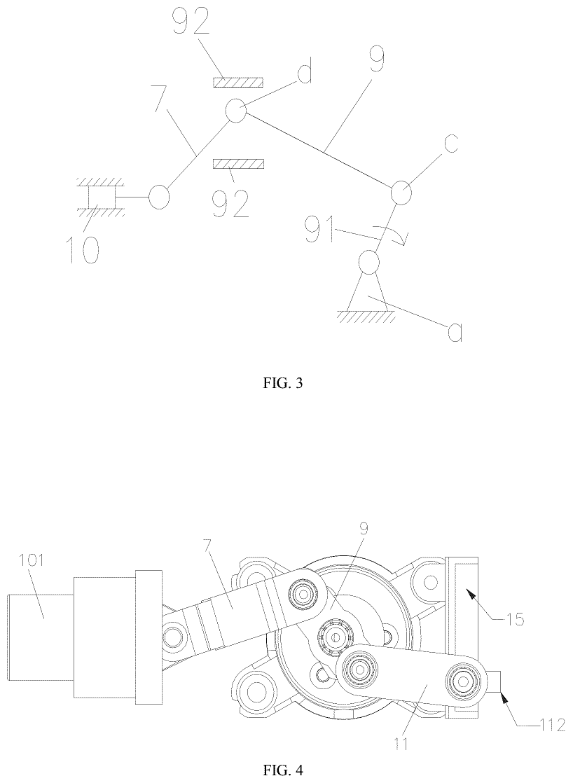

FIG. 1-FIG. 3 show a structure of a reciprocating drive mechanism of continuously variable amplitude and a control principle thereof. FIG. 1 shows a slider-crank mechanism composed of a crank 91, an output rod 9, a connecting rod 7 and a slider 10 that are hinged in sequence. FIG. 3 is a schematic diagram showing a limit baffle 92 being additionally provided at a swing hinge point d. The swinging range of the swing hinge point d is within the swinging range of the limit baffle 92. FIG. 2 is a schematic diagram of an output rod 9 being a connecting rod. FIG. 2 is taken as an example, the output rod 9 swings while rotation is transferred to an output hinge point c through the power source a of rotation. However, the right end of the swinging output rod 9 is bound by the adjusting rod 11, and its swinging amplitude and swinging range will be inevitably different from those in a normal state. The left end of the output rod 9 is rotatably connected with the connecting rod 7, and the connecting rod 7 moves while the output rod 9 swings and drives the slider 10 to reciprocate. During adjustment, the right end of the adjusting rod 11 (namely, the relative position of the rotation point g between the adjusting rod and the slider) slides, to be specific, the swinging trajectory of the output rod 9 can be adjusted by the adjusting rod 11 and the adjusting hinge point e, so that the swinging amplitude of the swing hinge point d is adjusted and the amplitude of the slider 10 is further adjusted. In the structure, in a case that the eccentric distance is not adjusted, the swinging amplitude of the output rod 9 and the swinging range thereof are adjusted, the related adjusting structure is obviously optimized, and the product facilitates mass production. In addition, this adjustment mode can also be applied during the use of the fascia gun, which greatly improves the convenience of use and user experience.

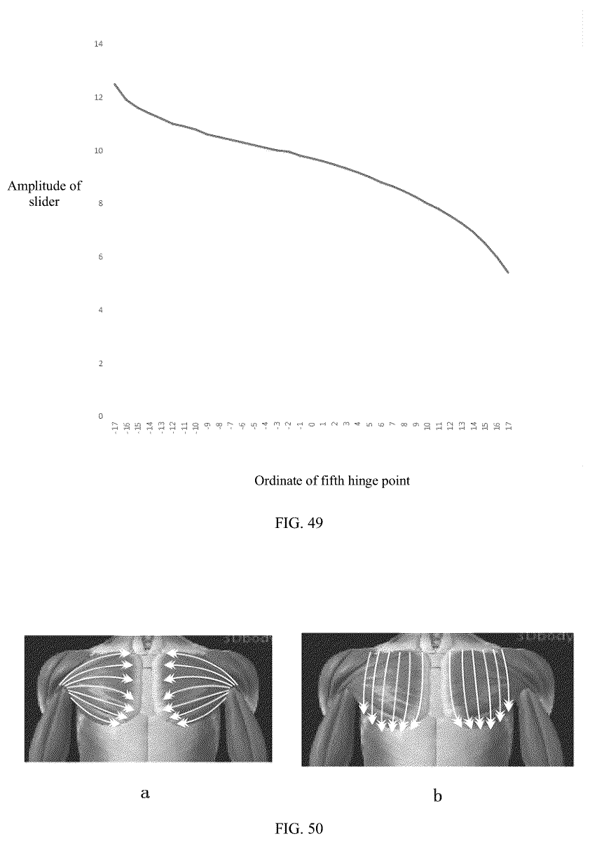

When the reciprocating drive mechanism of continuously variable amplitude is specifically designed according to the above structure and the control principle, it is key to obtain a relationship between the amplitude of the slider 10 and the slider rotation point g on the adjusting rod 11. A fifth hinge point shown in FIG. 49 is a function relationship curve between the coordinates of the slider rotation point g on the adjusting rod 11 and the amplitude of the slider. The hinge point between the connecting rod 7 and the slider 10 is a first hinge point, and the hinge point between the output rod 9 and the connecting rod 7 is a second hinge point, namely, the swing hinge point d. The hinge point between the output rod 9 and the eccentric wheel 16 is a third hinge point, namely, the output hinge point c. The adjusting rod 11 has a swinging end and an adjusting end, and the swinging end of the adjusting rod 11 is hinged on the output rod through a fourth hinge point, that is, the fourth hinge point is the adjusting hinge point e. The hinge point of the adjusting end of the adjusting rod 11 is the fifth hinge point, namely, the rotation point g between the adjusting rod and the slider. The fifth hinge point (namely the position of the rotation point g between the adjusting rod and the slider) is adjustable, by which the swinging range of the second hinge point is defined; the method includes: determining a first distance between the first hinge point and the second hinge point, a second distance between the second hinge point and the third hinge point, a third distance between the third hinge point and the fourth hinge point, and a function relationship between the position of the fifth hinge point and the amplitude of the slider, and designing the reciprocating drive mechanism of continuously variable amplitude based on the function relationship. In the reciprocating drive mechanism of continuously variable amplitude, the slider is rotatably connected with one end of the connecting rod through the first hinge point, the other end of the connecting rod is rotatably connected with one end of the output rod through the second hinge point, the center of the output rod is rotatably connected with the eccentric wheel through the third hinge point, the other end of the output rod is rotatably connected with the swinging end of the adjusting rod through the fourth hinge point, and the adjusting end of the adjusting rod is rotatably connected with a position adjusting mechanism through the fifth hinge point. Based on the above structure, when the rotating input end of the eccentric wheel rotates, the output rod swings back and forth along with the rotation of the eccentric wheel, and the connecting rod and the adjusting rod move along with the swing of the output rod. When the adjusting end of the adjusting rod is located at different positions, the swinging amplitude and swinging range of the second hinge point where the connecting rod is hinged with the output rod will change correspondingly, such change will be transmitted to the slider through the connecting rod, thereby changing the amplitude of the slider. In the above reciprocating drive mechanism of continuously variable amplitude, the eccentric distance of the eccentric wheel is basically fixed, and the amplitude of the slider mainly depends on the positions and lengths of the output rod, the connecting rod and the adjusting rod, but the amplitude change of the slider is relatively complicated. Based on this, according to the invention, a first distance between the first hinge point and the second hinge point, a second distance between the second hinge point and the third hinge point, a third distance between the third hinge point and the fourth hinge point, and a function relationship between the position of the fifth hinge point and the amplitude of the slider are determined, the reciprocating drive mechanism of continuously variable amplitude is designed based on the function relationship, specifically, the rotating connection position of the adjusting end of the adjusting rod and the lengths of the output rod and connecting rod that meet the function relationship can be selected according to the design requirements or the amplitude of the slider can be verified based on the function relationship, and a three-dimensional simulation model does not need to be established and repeatedly adjusted, which simplifies the design operation and improves the design efficiency.

As another form of the above-mentioned reciprocating drive mechanism of continuously variable amplitude, as shown in FIG. 33, its main improvement is that the output rod 9 is composed of a first output rod 3391 and a second output rod 3392 that are arranged in an intersecting way. Specifically, the first output rod 3391 and the second output rod 3392 form an L-shaped structure, and the slider-crank mechanism is composed of the crank 91, the output rod 9, the connecting rod 7 and the slider 10 that are hinged in sequence. When satisfying a spacing space among the hinge point of the adjusting rod 11 and output rod 9, the hinge point of the crank 91 and output rod 9, and the hinge point of the connecting rod 7 and output rod 9, the output rod 9 with the L-shaped structure can reduce the overall space of the output rod 9 in a length direction and further reduces the length of the reciprocating drive mechanism of continuously variable amplitude, so that the design of the mechanism is more compact and the fascia gun is minimized. Meanwhile, if the adjusting rod 11 is arranged on a side of the output rod 9 approaching the slider 10, the adjusting rod 11 is designed on a side of the mechanism so as not to extend the tail end of the fascia gun body. Meanwhile, the adjusting rod can be staggered with the handle arranged at the tail end of the fascia gun, thus reducing the probability of incorrect operation.

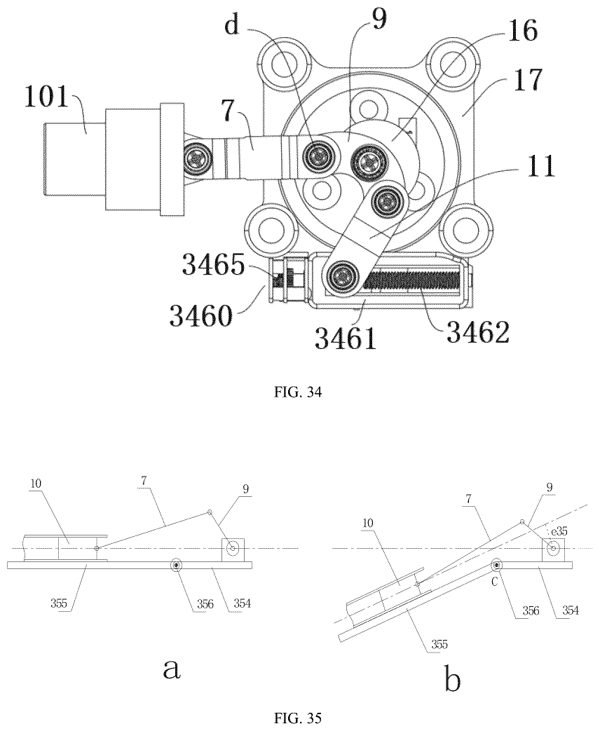

FIG. 34 shows an embodiment of the reciprocating drive mechanism of continuously variable amplitude as shown in FIG. 33. A specific shape of the output rod 9 can be the shape of a letter C, the shape of a letter V, or the shape of a letter W as shown in FIG. 34. The shape of the output rod 9 can make the whole structure of the reciprocating drive mechanism of continuously variable amplitude more compact, and the occupied space is also greatly saved. As for a specific adjusting mode, the embodiment provides an electronically controlled swing adjusting mechanism 3460, and the amplitude adjustment is more conveniently performed through the electronically controlled swing adjusting mechanism. The swing adjusting mechanism 3460 includes a mounting housing 3461, a threaded rotating rod 3462, a threaded block, a connecting block, a gear set 3465 and a driving motor, where the mounting housing 3461 is arranged on a motor fixing stand 17, the threaded rotating rod 3462 is arranged in the mounting housing 3461, one end of the threaded rotating rod passes through a side of the mounting housing 3461, and the threaded rotating rod 3462 is rotatably connected with the mounting housing 3461, the threaded block is arranged on the threaded rotating rod 3462 and is in threaded fit with the threaded rotating rod 3462, the connecting block is arranged at the top of the threaded block, the adjusting rod 11 is rotatably connected with the connecting block, the driving motor is arranged at the bottom of the mounting housing 3461, and the output end of the driving motor is rotatably connected with one end of the threaded rotating rod 3462 passing through the mounting housing 3461 through the gear set, so as to the threaded rotating rod 3462 to rotate. In use, the gear set is driven through forward rotation or backward rotation of the driving motor to drive the threaded rotating rod 3462 to rotate forward or backward, so that the threaded block in threaded fit with the threaded rotating rod 3462 moves back and forth on the thread of the threaded rotating rod 3462 to drive the connecting block arranged at the top of the threaded block to move back and forth, further changing the connecting position of the adjusting rod 11 on the swing adjusting mechanism 3460 and adjusting the swinging range of the rotary connection between the output rod 9 and the connecting rod 7, namely, the swinging range of the swing hinge point g, by this way, the piston 101 can reciprocate with continuously variable amplitude.

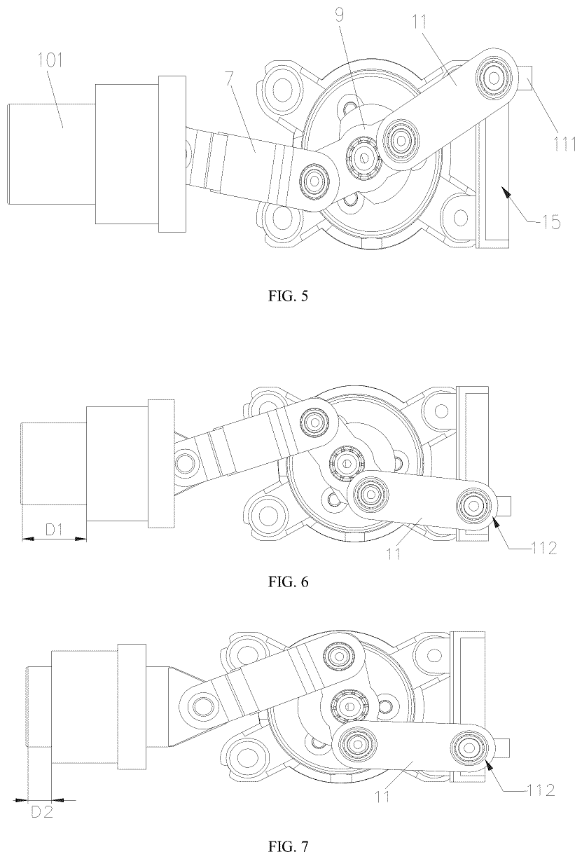

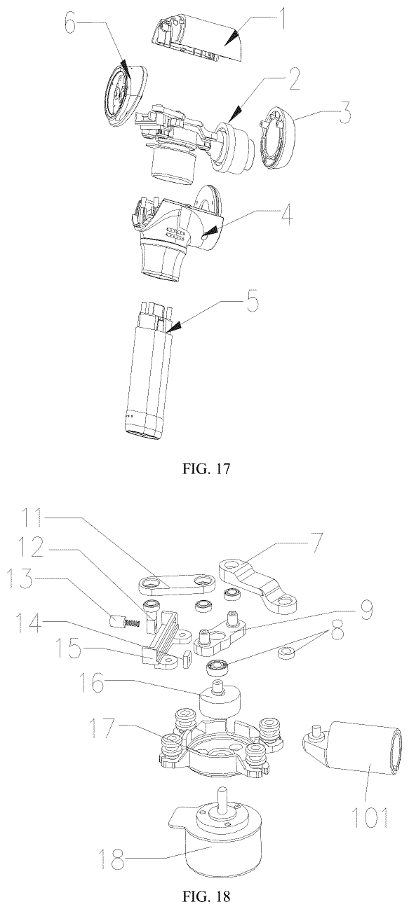

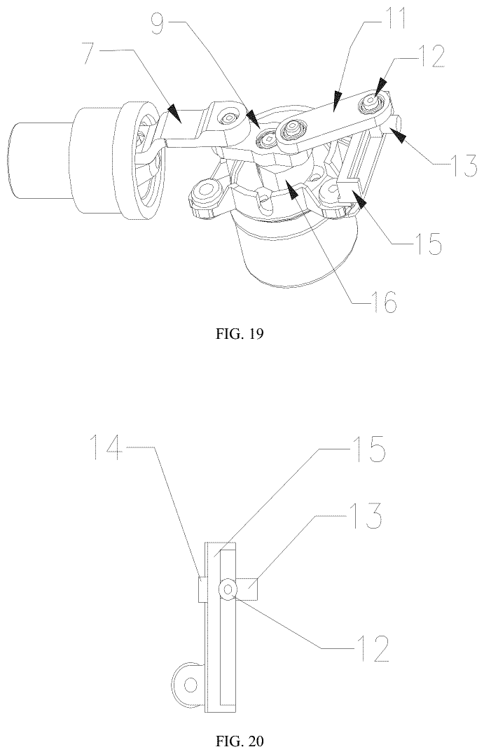

After the reciprocating drive mechanism of continuously variable amplitude is applied to a specific fascia gun product, its related structural schematic diagram is as shown in FIG. 4 to FIG. 20. Firstly, a mounting chamber is composed of a lower shell 4, an upper shell 1, a front cover 3 and a rear cover 6, the reciprocating drive mechanism 2 is arranged in the mounting chamber, and the piston 101 in the reciprocating drive mechanism 2 is slidably arranged in the piston hole of the front cover 3. As shown in FIG. 18, the motor 18 transmits the rotating power to the eccentric wheel 16 through the output shaft, and drives the eccentric wheel 16 to rotate. The rotating eccentric wheel 16 is rotatably connected with the output rod 9 through the output shaft of the eccentric wheel 1. The output rod 9 is rod-shaped, one end thereof is rotatably connected with the connecting rod 7, and the other end thereof is rotatably connected with the adjusting rod 11. After the above-mentioned infrastructure is connected, a specific structure as shown in FIG. 19 is obtained. During actual movement, the eccentric wheel 16 rotates with the output shaft of the motor 18, and the rotating eccentric wheel 16 drives the output rod 9 to swing accordingly. The amplitude of the piston 101 is constant when the position of the slider 12 at the adjusting end of the adjusting rod 11 is fixed. When the amplitude of the piston 101 needs to be adjusted, the threaded knob 13 is loosened and the position of the slider 12 is adjusted. As the position of the slider 12 is changed, the adjusting rod 11 will adjust the swinging state of the output rod 9 by adjusting the hinge point e, that is, it will adjust the swinging range of the swing hinge point d and then adjust the amplitude of the piston 101.

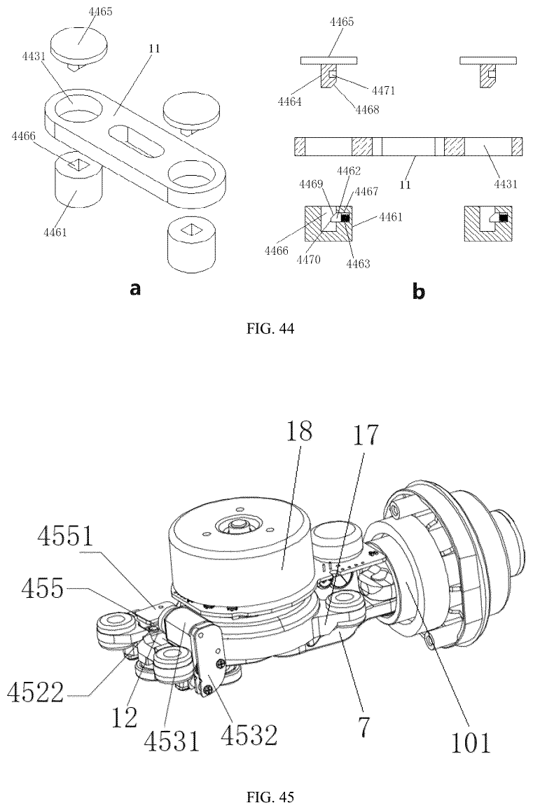

As for the connecting structure of the adjusting rod 11, in order to quickly connect two ends of the adjusting rod 11 to the output rod 9 and the slider 12 respectively, as shown in FIG. 44, an embodiment of a connecting structure of the two ends of the adjusting rod 11 is provided. In FIG. 44, one end of the adjusting rod 11 is hinged with the output rod 9, and the other end of the adjusting rod 11 is hinged with the slider 12. A specific hinge structure can choose the following scheme: including a fixing shaft 4461, a locking block 4462, a spring 4463, a clamping block 4464 and a baffle 4465. The fixing shaft 4461 is longitudinally arranged in the through hole 4431 and fits with the through hole 4431, the fixing shaft 4461 is in sliding contact with the inner wall of the through hole 4431, and fixedly connected with the slider 12 or the output rod 9. The top of the fixing shaft 4461 is provided with a clamping groove 4466 extending downward, and the side wall of the clamping groove 4466 is provided with a guide groove 4467 laterally extending outward. The locking block 4462 is arranged in the guide groove 4467 and is in sliding contact with the inner wall of the guide groove 4467. The spring 4463 makes the locking block 4462 tend to move inward and approach the clamping groove 4466. The clamping block 4464 is arranged in the clamping groove 4466 and fits with the clamping groove 4466, the clamping block 4464 is in sliding contact with the inner wall of the clamping groove 4466, and the side wall of the clamping block 4464 is provided with a locking groove 4471 laterally extending inward, and the locking groove 4471 fits with the locking block 4462. The baffle 4465 is fixedly mounted at the top of the clamping block 4464 to prevent the fixing shaft 4461 from being detached from the through hole 4431, and the baffle 4465 is in sliding contact with the top of the adjusting rod 11. A specific assembling process is that: firstly, through holes 4431 at both ends of the adjusting rod 11 are respectively fitted with the slider 12 and the output rod 9. Then, the baffle 4465 is removed and the clamping block 4464 is inserted into the clamping groove 4466, and when the clamping block 4464 moves down in the clamping groove 4466, the locking block 4462 is hidden in the guide groove 4467, and the spring 4463 is in a compressed state. When the locking block 4462 is aligned with the locking groove 4471, the locking block 4462 is inserted into the locking groove 4471 under the action of the spring 4463, in this case, the baffle 4465 just contacts with the top of the adjusting rod 11, and the adjusting rod 11 is fitted with the fixing shaft 4461 and can rotate freely. In the solution, the two ends of the adjusting rod 11 are quickly connected with the output rod 9 and the slider 12, in subsequent use, the slider 12 or the adjusting rod 11 with an approximate length can be replaced according to use requirements to achieve more diverse use functions.

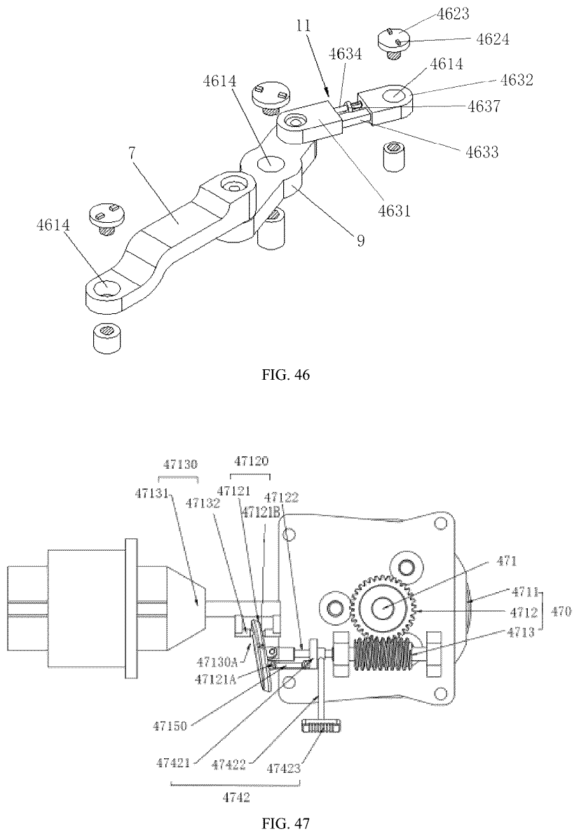

FIG. 46 shows a solution that the length of the adjusting rod 11 can be adjusted directly to achieve amplitude adjustment. In FIG. 46, the adjusting rod 11 includes a first rod body 4631, a second rod body 4632, a guide rod 4633 and a rotating rod 4634. The first rod body 4631 is opposite to the second rod body 4632, and both sides of the outer end surface of the first rod body 4631 are respectively provided with the guide groove and the threaded groove that laterally extend inward. The first end of the guide rod 4633 is fixedly connected with the second rod body 4632, and the second end of the guide rod 4633 is in sliding contact with the inner wall of the guide groove. The first end of the rotating rod 4634 is rotatably connected with the second rod body 4632, and the second end of the rotating rod 4634 is in threaded fit with the threaded groove. When the rotating rod 4634 is controlled to rotate, because the second end of the rotating rod 4634 is in threaded fit with the threaded groove, the first rod body 4631 and the second rod body 4632 approach or move away from each other under the action of the guide rod 4633, thereby changing the overall length of the adjusting rod 11 and further changing the amplitude adjustment range of the piston 101. In a case that the sizes of the output rod 9 and the connecting rod 7 do not change, such arrangement is also suitable for adjusting the provision position where an inserting hole 4614 in the adjusting rod 11 is corresponding to the slider 12 in the fascia gun, so that the existing fascia gun is improved into a fascia gun with a variable amplitude mode at a minimum cost. In addition, a fixing post at the bottom of the baffle 4623 is longitudinally arranged in the inserting hole 4614 and is in sliding contact with the inner wall of the inserting hole 4614, and the top of the fixing post is provided with a threaded hole extending downward. The baffle 4623 is used to prevent the fixing post from being detached from the inserting hole 4614. All threaded posts are removed from corresponding threaded holes by turning the baffle 4623, so as to facilitate the disassembly of the adjusting rod 11, the output rod 9 and the connecting rod 7, and then mount the adjusting rod 11, the output rod 9 and the connecting rod 7 that have different sizes. When the sizes of the adjusting rod 11, the output rod 9 and the connecting rod 7 are changed, the amplitude adjustment range of the piston 101 can also be changed to fit with the housings of the fascia guns with different internal space sizes.

FIG. 6 to FIG. 11 are taken as an example; when the right end of the adjusting rod 11 is in the position as shown in FIG. 6, that is, when the right end of the adjusting rod 11 is in the position 112 of the slider, the piston 101 is within a maximum amplitude range. FIG. 6 shows the state of the piston 101 moving to the leftmost end, where a distance D1 between the left end of the piston 101 and a piston bush is 19.9 mm. FIG. 7 shows the state of the piston 101 moving to the rightmost end, where a distance D2 between the left end of the piston 101 and a piston bush is 6.8 mm, and therefore the amplitude stroke of the piston 101 is 19.9−6.8=13.1 mm.

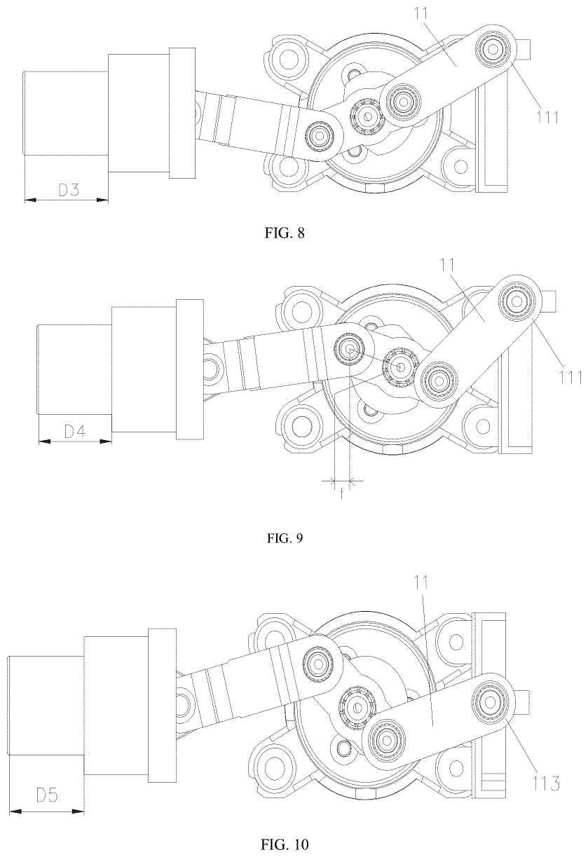

When the right end of the adjusting rod 11 is in the position as shown in FIG. 8 and FIG. 9, that is, when the right end of the adjusting rod 11 is in the position 111 of the slider, the piston 101 is within a minimum amplitude range. FIG. 8 shows the state of the piston 101 moving to the leftmost end, where a distance D3 between the left end of the piston 101 and a piston bush is 26 mm. FIG. 9 shows the state of the piston 101 moving to the rightmost end, where a distance D4 between the left end of the piston 101 and a piston bush is 21.7 mm, and therefore the amplitude stroke of the piston 101 is 26−21.7=4.3 mm.

When the right end of the adjusting rod 11 is arranged between the above two limit positions, as shown in FIG. 10 and FIG. 11, that is, when the right end of the adjusting rod 11 is in the position 113 of the third slider, the amplitude range of the piston 101 is between the maximum range and the minimum range. FIG. 10 shows the state of the piston 101 moving to the leftmost end, where a distance D5 between the left end of the piston 101 and a piston bush is 26.3 mm. FIG. 11 shows the state of the piston 101 moving to the rightmost end, where a distance D6 between the left end of the piston 101 and a piston bush is 16 mm, and the amplitude stroke of the piston 101 is 26.3−16=10.3 mm.

According to the above three positions, the amplitude stroke of the corresponding piston 101 can be adjusted in the range of 4.3 mm to 13.1 mm.

In addition, FIG. 16 also elaborates the relationship between angle adjustment and amplitude change in the above structure. In FIG. 16, point O is the center of the motor shaft, the rotation point g between the adjusting rod and the slider is the rotation center of the adjusting rod, the adjusting hinge point e is the rotation connection point between the output rod and the adjusting rod, the output hinge point c is the rotation connection point between the output rod and the eccentric wheel, and the swing hinge point d is the rotation connection point between the swinging arm and the output rod; an included angle between segment og and the abscissa axis is β, namely, a second included angle β, and an included angle between segment od and the abscissa axis is θ, namely, a first included angle θ. When the motor rotates with the eccentric wheel, because the swinging arm is limited by the adjusting rod, it can make a plane motion, that is, it swings back and forth, when the second included angle β is changed, the swinging arm is driven to swing within the corresponding swinging range with the first included angle θ, and the piston rod is driven to reciprocate within the corresponding amplitude F, this shows that the amplitude F increases with the decrease of the second included angle β. When the position of the rotation point g is changed and is corresponding to the second included angle β, a projection distance difference between the swing limit positions of the segment od in a horizontal direction is the current reciprocating distance F of the piston, and the included angle between by the segment od and the horizontal direction in a reciprocating swing process is changed in the range of θmax˜θmin, that is, F=od*|Cos θmax−Cos θmin|, and od is L1. The amplitude F is adjusted by changing the position of the rotation point g (namely, changing the position of the second included angle β), this shows that the amplitude F increases with the decrease of the second included angle β, and the position of the rotation point g is continuously adjusted to realize the continuous adjustment of the corresponding amplitude F. The amplitude F is adjusted in the range of Fmax−Fmin. The second included angle β ranges from −20°-30°; and the first included angle θ ranges from −20°-90° (excluding) 90°. A relationship among the second included angle β, the first included angle θ and the amplitude F can be explained by the following experimental data list and with reference to FIG. 16:

| | | Coordinate of | | Coordinate of | |
|---|---|---|---|---|---|
| | Second | point g | First | point d | Amplitude F |
| | included | (og*Cosβ, | included | (od*Cosθ, | F = od*\|Cosθmax − |
| SN | angle β | og*Sinβ) | angle θ | od*Sinθ) | Cosθmin\| |
| 1 | 27° | (36.8, 19) | θmin = −22° | Point min: | 4.61 |
| | | | θmax = 24° | (−12.68, 5.75) | |
| | | | | Point max: | |
| | | | | (−17.29, −5.73) | |
| 2 | 16° | (36.8, 10.5) | θmin = 16° | Point min: | 8.63 |
| | | | θmax = 56° | (−8.59, 12.83) | |
| | | | | Point max: | |
| | | | | (−17.22, 4.79) | |
| 3 | −19° | (36.8, −12.94) | θmin = 45° | Point min: | 11.95 |
| | | | θmax = 88° | (−0.47, 15.75) | |
| | | | | Point max: | |
| | | | | (−12.42, 12.62) | |

It can be seen from the above test data and FIG. 16 that when the second included angle β gradually decreases in the range of 27° to −19°, the amplitude F gradually increases, and the adjustable range of the amplitude is 11.95−4.61=7.34 mm. Furthermore, when the adjusting rod 11 is used to adjust the second included angle β in the range of −19° to 27°, the adjustable range of the amplitude of the piston is 7.34 mm, that is, the amplitude is varied and adjusted in the range of 4.61 mm to 11.95 mm.

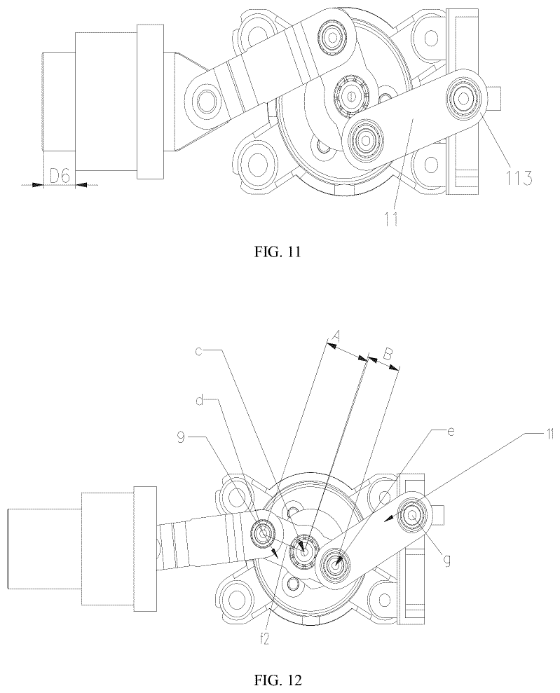

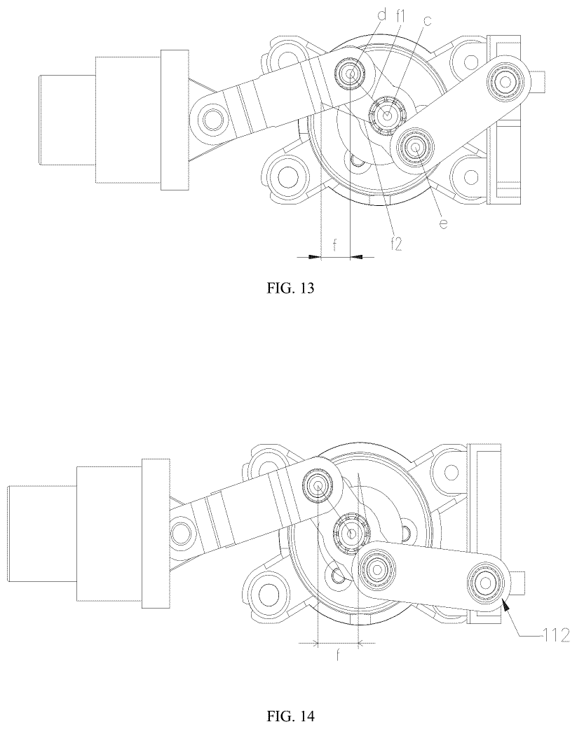

In FIG. 12, a spacing between the output hinge point c and the swing hinge point d is a first spacing A, and a spacing between the output hinge point c and the adjusting hinge point e is a second spacing B. When the output rod 9 is located in the second limit swing position f2 of the output rod as shown in FIG. 13, its axis is marked as f2. When the output rod 9 is in the first limit swing position f1 of the output rod as shown in FIG. 14, its axis is marked as f1. The position f2 and the position f1 are projected on the straight line where the piston 10 reciprocates, and a difference in projection lengths obtained through projection is marked as f, and is the amplitude f of the piston, namely, the amplitude stroke as mentioned above. The schematic diagram of the corresponding projection is also marked in FIG. 14.

As for the way to adjust the position of the adjusting end of the adjusting rod 11 to implement the amplitude adjustment, FIG. 37 provides a way to make full use of three-dimensional space for amplitude adjustment. The output rod 9 and the adjusting rod 11 are connected by a spherical hinge 3711 to achieve power transmission in the three-dimensional space. Including a guide rail 3720, guide rail 3720 is provided and detachably connected with a rear cover 3710, specifically, the guide rail 3720 has a curvilinear structure adapted to adjusting the current amplitude range of the fascia gun, and the curvilinear amplitude in the curvilinear amplitude can be corresponding to the amplitude of the current position, therefore, the guide rail can be integrated on the mounting plate to form a replaceable standard module, and a standard module can be directly switched and mounted on the rear cover to adjust different amplitudes. The structural form of the guide rail 3720 needs to be changed because different amplitude ranges are corresponding to different moving ranges of the adjusting end of the adjusting rod 11 during the adjustment, and when such adjustment is suitable for the amplitude adjustment of the corresponding fascia gun, the current amplitude can be indicated by the position on the guide rail, and it is necessary to match the curve structure formed by the current guide rail 3720 with the amplitude adjustment range. In fact, in a case that the amplitude adjustment range of the fascia gun is determined, the curvilinear structure of the guide rail 3720 is also uniquely determined. A sliding ball is provided on the guide rail 3720, and the sliding ball is in sliding contact with the guide rail 3720. One end of the adjusting rod 11 is universally connected with the sliding ball through a universal ball. For example, the position of the sliding ball can be adjusted outside the back cover 3710 to change the position of the adjusting rod 11, so that the spatial angle of the adjusting rod 11 is changed, and the amplitude range of the hinge end of the adjusting rod 11 and output rod 9 is limited to the current amplitude range after such adjustment.

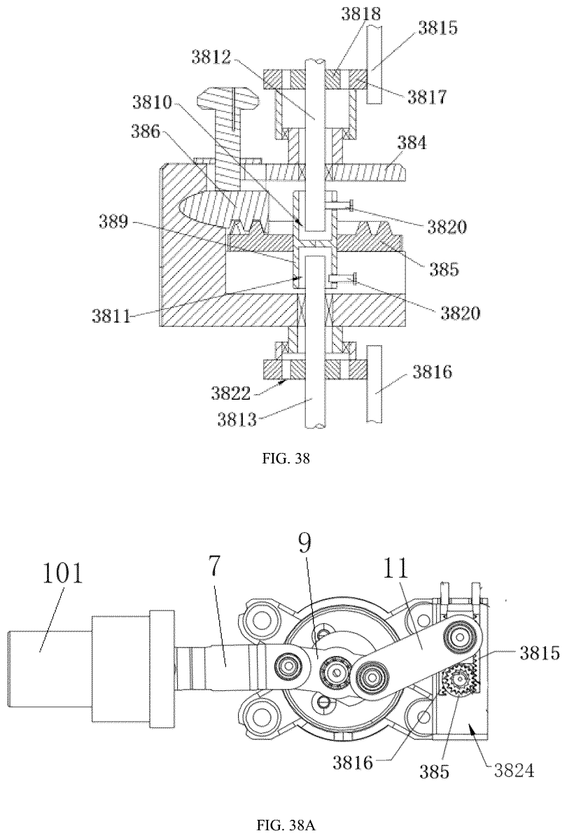

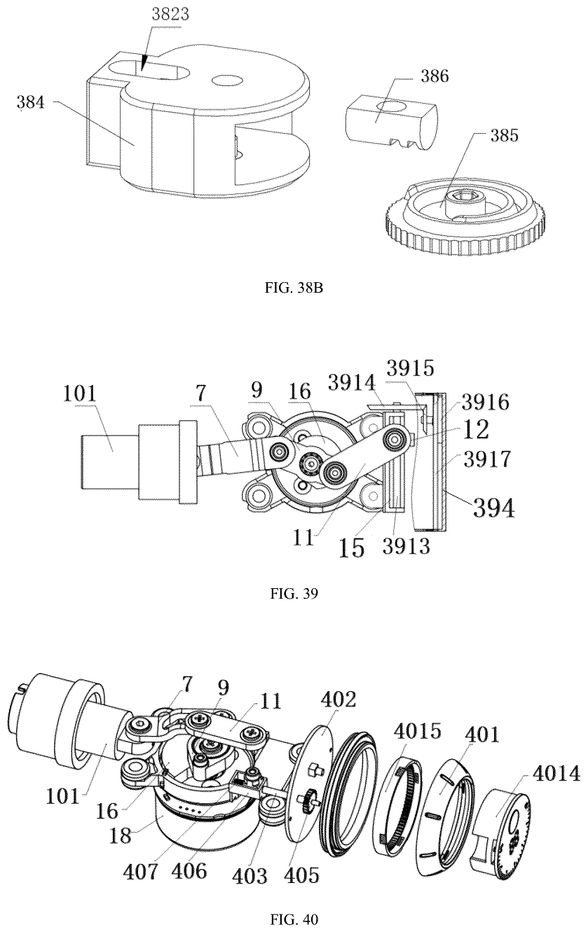

FIG. 38 shows a structure where an amplitude is manually adjusted by pressing an adjusting structure. The adjusting end of the adjusting rod 11 is provided with a position adjusting mechanism, and the position adjusting mechanism drives the adjusting end of the adjusting rod 11 to move by pressing. FIG. 38 shows an embodiment of the position adjusting mechanism. The adjusting end of the adjusting rod 11 is connected with a cylindrical rack 386, and the adjusting end of the adjusting rod 11 is rotatably connected with the cylindrical rack 386 through a plug screw or pin. In the embodiment, clockwise rotation of a spiral gear 385 is forward rotation and counterclockwise rotation thereof is reverse rotation. When the amplitude needs to be increased, the screw 3820 below the shaft sleeve 389 is loosened and the screw 3820 at the upper end of the shaft sleeve 389 is tightened. In this case, the rotation of a first driving shaft 3812 will drive the shaft sleeve 389 to rotate because the screw 3820 is limited, when the shaft sleeve 389 rotates, the shaft sleeve 389 can rotate in relation to a second driving shaft 3813 because the second driving shaft 3813 is not limited. A first adjusting button is pressed to drive a first rack to descend 3815, and when the first rack 3815 descends, a first unidirectional driving gear 3814 is driven to rotate. The rotation of the first unidirectional driving gear 3814 will drive the first driving shaft 3812 to rotate, in this case, the first driving shaft 3812 drives the spiral gear 385 to rotate forward through the shaft sleeve 389. The spiral gear 385 rotates forward to drive the cylindrical rack 386 to descend, thereby allowing the adjusting end of the adjusting rod 11 to move, after adjustment, the amplitude of the fascia gun increases. During adjustment, an electric outer gear ring 3817 of the first rack 3815 rotates forward, and drives an inner turning disc 3818 to rotate through a ratchet slot and a pawl 3819, and the first driving shaft 3812 rotates with the inner turning disc 3818. When the first adjusting button is reset, the first rack 3815 is driven to reset, and the first rack 3815 drives the outer gear ring 3817 to rotate reversely, in this process, the outer gear ring 3817 will not drive the inner turning disc 3818 to rotate due to the presence of the ratchet and the pawl 3819, thus ensuring that the position of the adjusting end of the adjusting rod 11 is not affected by the reset of the first rack 3815 after the adjusting rod is pressed. However, when the amplitude needs to decrease, such operation is made in a way opposite to the above operation. Loosening the screw 3820 above the shaft sleeve 389, tightening the screw 3820 at the lower end of the shaft sleeve 389, and driving the second driving shaft 3813 through the second rack 3816 corresponding to the second adjusting button, this may be similar to a driving process. Purely mechanical push-type adjustment is used in the embodiment, so amplitude increase and decrease can be implemented; there is no problem of extra energy consumption during use, and there is no problem of proneness of water and dust entry caused by large size.

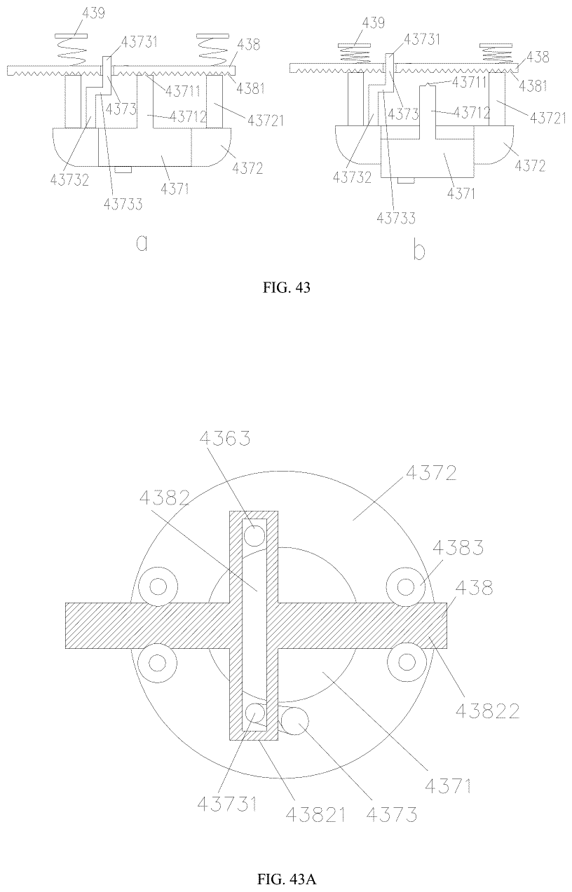

FIG. 43 and FIG. 43A show a structure where amplitude adjustment is implemented by mechanically adjusting the knob, the solution is mainly to move the guide rod 43822 horizontally from left to right, drive the slider 12 through the guide rod 43822, and move the slider 12 in the direction of the limit chute 15. Specifically, an operation process is changed from the rotation of the rotating knob 4372 to the sliding of the slider 12. The inner cover 4371 of the knob and the rotating knob 4372 are mainly provided. Wherein, the rotating knob 4372 is of an annular structure and is rotatably arranged outside the inner cover 4371 of the knob, the inner cover 4371 of the knob can be clamped or screwed on the inner wall surface of the housing of the fascia gun; a control main board, a display, keys, and other structures on the existing fascia gun can be integrally mounted through the inner cover 4371 of the knob, in addition, the inner cover can support the rotating knob 4372. In actual use, the rotating knob 4372 is rotated to pull a base rod 43732, a bending connecting part 43733 and a driving rod 43731 to rotate, and the driving rod 43731 under rotation slides in a linkage groove of a linkage rod 438 to generate a horizontal traction force. In FIG. 43, the driving rod 43731 passes through the linkage groove of the linkage rod 438, and the linkage groove extends in a direction perpendicular to a plane as shown in FIG. 43. Specifically, the base rod 43732 is eccentrically arranged in relation to the rotating knob 4372, so that when the rotating knob 4372 pulls the base rod 43732 to generate a tangential force under rotation, the bending connecting part 43733 drives the driving rod 43731 to move in a tangential direction, when the driving rod 43731 is limited by the linkage groove, the driving rod 43731 will slide in the linkage groove and drive the linkage groove to move horizontally, further driving the threaded head end to move horizontally. In a process of horizontal movement, the threaded head end drives the slider 12 connected with it to move in the direction of the limit chute 15, so as to finally adjust the amplitude.

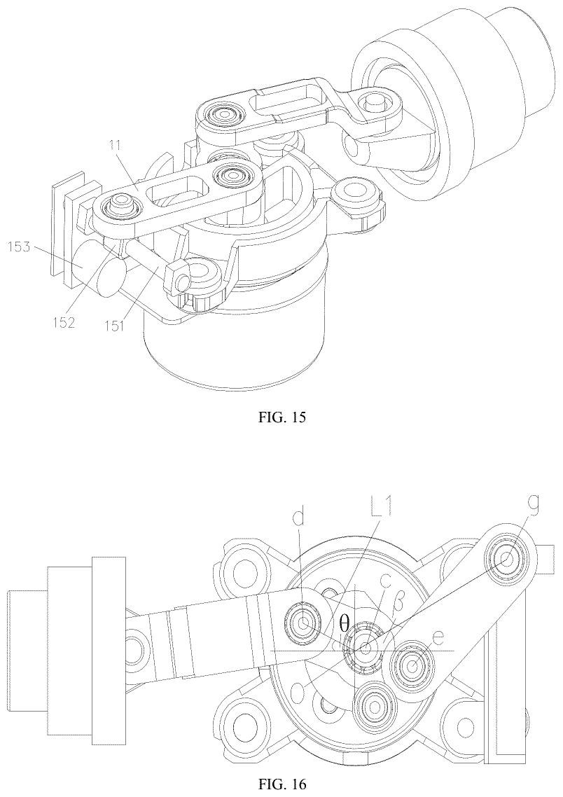

FIG. 15 shows a state in which a position adjusting mechanism is a lead screw 151 and a lead screw nut 152. Compared with the adjusting way of the slider 12, the driving adjusting way of the lead screw 151 and the lead screw nut 152 can better realize the effect of the electrically driven continuous adjustment, so that the amplitude adjustment of the piston 101 is more accurate and convenient, and is more conducive to being used in fascia gun products. During actual use, the driving unit 153 drives the lead screw 151 to rotate, and relative rotation is made between the lead screw 151 under rotation and the lead screw nut 152, under the action of the thread between the lead screw and the lead screw nut 152, such relative rotation drives the lead screw nut 152 to slide along the axial direction of the lead screw 151, and the lead screw nut 152 is slidably mounted, specifically, a guide sliding rod passing through the lead screw nut or a chute structure for guiding and limiting the sliding of the lead screw nut 152 can be adopted, so that the spiral motion between the lead screw nut 152 and the driving lead screw 151 can be changed into the sliding of the lead screw nut 152, to adjust the position of the adjusting end of the adjusting rod 11.

In actual design, the arrangement position and structural form of the position adjusting mechanism only needs to ensure that the adjusting end of the adjusting rod 11 can be driven to move in relation to a position. Therefore, the position adjusting mechanism can be linear or curvilinear. In addition, a position relationship between the position adjusting mechanism and the output rod 9 is also based on a fact that the adjusting end of the adjusting rod 11 can be driven to move in relation to a position.

In the above embodiment, it has been explained that the amplitude adjustment can be realized mainly by adjusting the position of the adjusting end of the adjusting rod 11, and the sliding of the lead screw nut 152 can be controlled to realize the corresponding amplitude adjustment after the lead screw 151 is driven to rotate, a control mode of driving the lead screw 151 will be described as follows.

A first way is that the motor drives the lead screw 151 to rotate, specifically, during the amplitude adjustment, the motor is controlled and adjusted.

FIG. 22 shows a way to control the motor by triggering a controller signal via a trigger element. The motor is used as a driving member to control the rotation of the lead screw 151, specifically, the motor includes a controlling module, where the controlling module includes the controller, the trigger element for triggering the controller signal and the driving member connected with the controller signal, after the signal input end of the controller receives the signal of the trigger element, the signal output end of the controller controls the driving member to drive the adjusting end of the adjusting rod 11 to move and control the direction and distance of the single displacement of the adjusting end of the adjusting rod 11, that is, the signal output end of the controller controls the driving member to drive the slider 12 to move and control the direction and distance of the single displacement of the slider 12. In actual design, the controller may be a conventional single-chip microcomputer in the prior art, or the controller controlled by PLC programs or other types of micro-controllers. The single-chip microcomputer is taken as an example, and a signal pin of the trigger element can be connected with an input pin of the single-chip microcomputer, so that the trigger element can trigger the signal of the single-chip microcomputer, a control pin of the driving member can be connected with an output pin of the single-chip microcomputer, so that the single-chip microcomputer can control the opening and closing of the driving member and the movement stroke thereof.

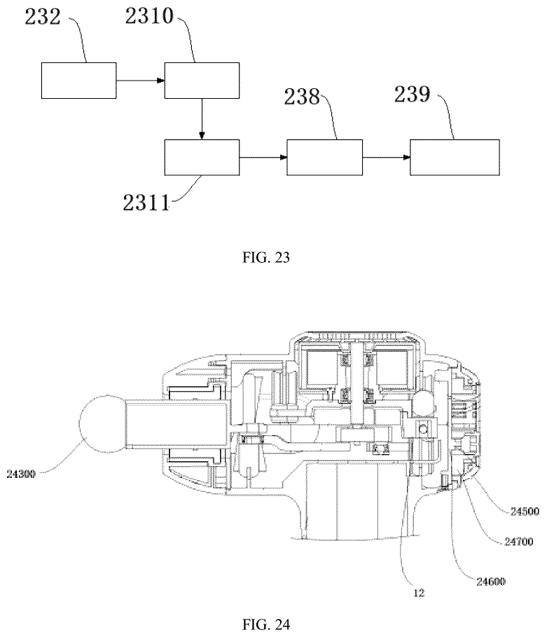

FIG. 23 shows another embodiment of motor control, and a touch screen is operated to adjust signal input so as to control the motor. Specifically, an MCU (micro control unit) 2310, a driving module 2311 and a touch screen 232 mounted on the rear cover of the fascia gun are provided; and the touch screen 232 is clamped in the mounting hole in the rear cover through a clamping component. A signal output end of the touch screen 232 is electrically connected with an signal input end of the MCU2310, a signal output end of the MCU2310 is electrically connected with a signal input end of the driving module 2311, a signal output end of the driving module 2311 is electrically connected with a signal input end of the motor 238, and an output end of the motor 238 is connected with an input end of an amplitude adjusting mechanism 239. The amplitude adjusting mechanism 239 is controlled to adjust the amplitude according to the finger sliding area in an arc area, and the amplitude is displayed on a display panel in real time by lighting up the sliding area. In use, touch signals generated during finger sliding are collected through the touch screen 232 and input into the MCU2310, and the MCU2310 is used to analyze and process received signals, if collected touch signals increase the amplitude on the original basis, the MCU2310 controls the motor 238 to rotate forward through the driving module 2311, and then controls the amplitude adjusting mechanism 239 to increase the vibration amplitude, if collected touch signals decrease the amplitude on the original basis, the MCU2310 controls the motor 238 to rotate backward through the driving module 2311, and the amplitude adjusting mechanism 239 is further controlled to avoid the reduction of the vibration amplitude.

A second way is to control the operation of the motor manually to drive the lead screw to rotate, and then realize the amplitude adjustment. The following describes the corresponding embodiment.

FIG. 39 shows a solution where the lead screw is driven by manually driving the gear ring knob to adjust the amplitude of the fascia gun. The adjusting rod 11 has a swinging end and an adjusting end, and the swinging end of the adjusting rod 11 is hinged on the output rod 9, the hinge position of the adjusting end of the adjusting rod 11 is adjustable, specifically, in order to adjust the hinge position of the adjusting end of the adjusting rod 11, the adjusting module also includes the slider 12 and the driving member for driving the slider 12 to slide, the adjusting end of the adjusting rod 11 is hinged on the slider 12, provided that the position of the slider 12 is moved, the adjusting end of the adjusting rod 11 can be driven to move. In order to define the movement track range of the slider 12, the adjusting module further includes a limit chute 15 for the slider 12 to slide. The driving member includes the lead screw 3913, and the slider 12 is in threaded connection with the lead screw 3913, the rotation of the lead screw 3913 is controlled so that the slider 12 can slide back and forth in the limit chute 15. The inner wall of the knob 394 is fixed with an inner gear ring 3917, and the driving member also includes a driving gear 3916 meshed with the inner gear ring 3917, the driving gear 3916 is used for driving the lead screw 3913 to rotate, specifically, the lead screw 3913 is rotatably connected into the limit chute 15, and the end of the lead screw 3913 extends out of the limit chute 15 and is used to drive the driving gear 3916, in the embodiment, with the adjusting rod 11 being arranged at the tail end of the mechanism, when the sliding direction of the adjusting end of the adjusting rod 11 is perpendicular to the axis of the knob part 394, a driven bevel gear 3914 is fixed on the lead screw 3913, and a driving bevel gear 3915 meshed with the driven bevel gear 3914 is coaxially fixed on the driving gear 3916, therefore, such provision of the driving bevel gear 3915 and the driven bevel gear 3914 enables the driving gear 3916 to drive the lead screw 3913 to rotate. The knob part is provided as a part of an end cover, and the end cover is used as a part of the body of the fascia gun, namely, the knob 394 is adaptively fused to the original body of the fascia gun without protruding from the housing of the fascia gun, and the original size of the housing of the fascia gun is not changed, therefore, the fascia gun is more beautiful. Specifically, in use, the knob 394 drives the lead screw 3913 to rotate under driving of the inner gear ring 3917 and the driving gear 3916, so as to adjust the position of the adjusting end of the adjusting rod 11.

Of course, the position of the adjusting end of the adjusting rod 11 can also be adjusted by manually turning a knob switch, and then the amplitude can be adjusted. FIG. 24 shows an embodiment where amplitude adjustment is implemented by manually turning the knob switch. The knob switch 24500 is arranged outside the housing to facilitate its manual rotation by a user, specifically, the knob switch 24500 can be provided with anti-slip threads to increase friction and facilitate rotation by the user. An encoder switch 24700 is used to detect the rotation angle of the knob switch 24500, the main board 24600 is used to adjust the amplitude of the massage head 24300, and the encoder switch 24700 can be integrated on the main board 24600. When the amplitude of the massage head 24300 needs to be adjusted, the user only needs to manually rotate the knob switch 24500, after detecting the rotation angle of the knob switch 24500, the encoder switch 24700 sends a detection signal to the main board 24600, and the main board 24600 adjusts the amplitude of the massage head 24300. Of course, the rotating knob is rotated at different angles to adjust the amplitudes at different gears, for example, when the rotating knob is rotated by an angle of 30°, the amplitude is a first gear, and when the rotating knob is rotated by an angle of 60°, the amplitude is a second gear, by analogy, the user can adjust the amplitude gear of the massage head 24300 by rotating the knob switch 24500 to different angles according to actual needs, therefore, such adjustment is more convenient and faster, thereby increasing the convenience of the amplitude adjustment of the massage head 24300.

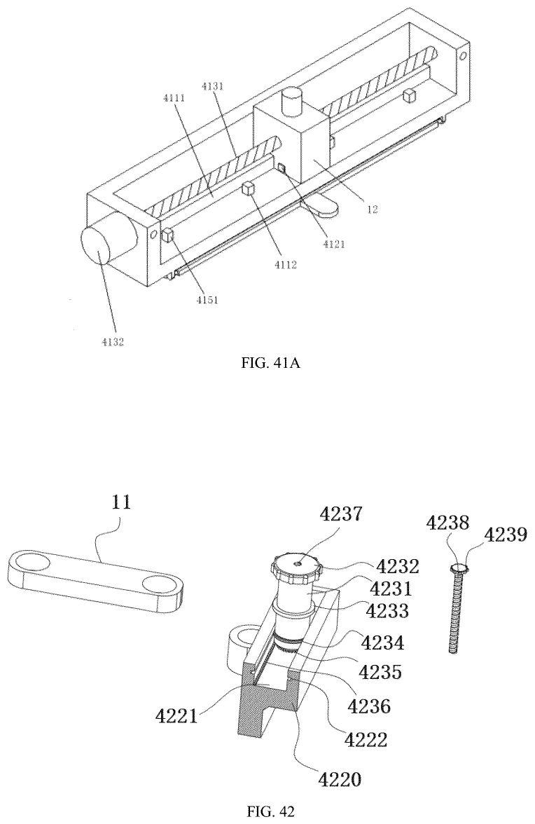

FIG. 42 shows an embodiment where amplitude adjustment is implemented through a manual knob and a rack. The adjusting end of the adjusting rod 11 is hinged with the rotating shaft 4231. A slide carriage 4220 is provided, a chute I 4221 is arranged on the slide carriage 4220; a rotating adjusting part is further provided and includes a rotating shaft 4231, a gear ring 4235 and a rack 4236; the rack 4236 is fixedly mounted at the bottom of the chute I 4221 and arranged along a length direction; the rotating shaft 4231 passes through the chute provided in the housing and is inserted into the chute 21; the gear ring 4235 is sleeved at the bottom end of the rotating shaft 4231, fits with the rack 4236, and is located on the rotating shaft 4231 between the housing and the slide carriage 4220 and rotatably connected with the adjusting end of the adjusting rod 11, in other words, when the position of the adjusting end of the adjusting rod 11 in relation to the chute I 4221 in the length direction needs to be controlled, the adjusting end of the adjusting rod 11 is driven to slide in the length direction of the chute I 4221 by controlling the rotation of the rotating shaft 4231. A lock is mounted on the rotating shaft 4231. After the adjustment, the lock can contact with the inner bottom surface of the chute I 4221, and the sliding of the rotating shaft along the length direction of the chute I 4221 is prevented by the friction force of the contact. Such control can satisfy the requirement that the adjusting rod is relatively stable when the fascia gun is in constant amplitude operation, that is, the amplitude of the fascia gun is stable. The lock includes a threaded rod 4238 and a knob II 4239 with one end connected; the center of the rotating shaft 4231 is provided with a threaded hole 4237; the threaded rod 4238 fits with the threaded hole 4237, and the friction between one end of the rotating shaft 4231 and the slide carriage 4220 is controlled by the knob II 4239 to control the sliding of the rotating shaft 4231 along the length direction of the chute I 4221. The slide carriage 4220 is also symmetrically provided with a clamping groove 4222, and the clamping groove 4222 is symmetrically concave along both sides in the length direction of the chute I 4221; the rotating shaft 4231 is provided with a snap ring 34, and at least parts of both sides of the snap ring 4234 are inserted into the clamping groove 4222 in the same side. Through the design, the circumferential slip of the rotating shaft 4231 can be avoided, and the stability of meshing between the gear ring 4235 and the rack 4236 can be increased. The rotating shaft 4231 is also provided with a retaining ring 4233, and the section of the rotating shaft 4231 between the retaining ring 4233 and the slide carriage 4220 is rotatably connected with the adjusting end of the adjusting rod 11; the retaining ring 4233 is provided to limit the adjusting end of the adjusting rod 11, so as to avoid sliding along the circumferential direction of the rotating shaft 4231 and increase the stability of structural connection; a bearing can also be mounted in the rotating groove arranged in the adjusting end of the adjusting rod 11 to reduce the friction force of rotating connection. The solution has the characteristics of simple structure, low manufacturing cost and self-locking stability.

FIG. 40 and FIG. 40A show an embodiment where amplitude adjustment is manually implemented through the gear ring knob. The rotation axis of the lead screw 407 is parallel to the reciprocating sliding trajectory of the piston 101, in the embodiment, the rotation axis of the lead screw 407 is parallel to the rotation axis of the rotating cover 401, the transmission member includes a driving gear 4015 fixed on the rotating cover 401 and a driven gear 405 fixed at the end of the lead screw 407, the driving gear 4015 and the driven gear 405 are meshed and driven, specifically, the driving gear 4015 is an inner gear, the end of the lead screw 407 extends to the driving gear 4015, in the actual design, a polished rod can be designed at the extended part of the end of the lead screw 407, so that the driving gear 4015 can directly drive the lead screw 407 to rotate through the driven gear 405, and therefor the design structure is simple. A through hole through which the fixing cover 4014 passes is provided at the center of the rotating cover 401, so that the surface of the fixing cover 4014 can be exposed. An indicator includes a pointer fixed on the rotating member, in the embodiment, the pointer can be arranged inside the rotating cover 401 instead of being exposed, a distance induction lamp is turned on or off by sensing a distance between the pointer and the distance induction lamp, and may be an ultrasonic induction lamp and a microwave induction lamp in the prior art, that is, an ultrasonic sensor, a microwave sensor and the like are built in the lamp to detect whether the pointer approaches or departs from the lamp, when the pointer approaches the lamp, the lamp is on, and when the pointer departs from the lamp, the lamp is off.

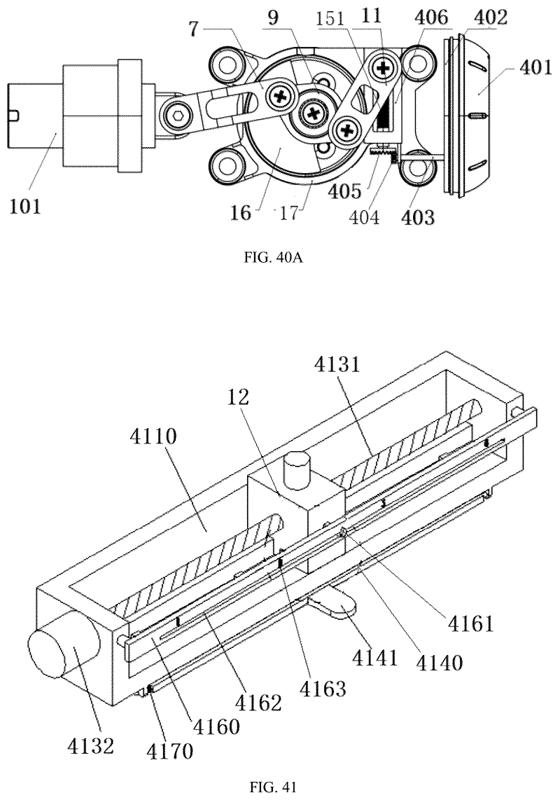

FIG. 41 and FIG. 41A show an embodiment where the amplitude adjustment is accurately implemented by a torsion spring. Including the fixing holder 4110, the slider 12, the driving member, the rotating plate 4140 and a plurality of blocking elements are provided. The fixing holder 4110 is fixedly mounted on the housing of the fascia gun, and the guide rail 4111 extending transversely is fixedly mounted on the fixing holder 4110. The fixing holder 4110 is provided with a plurality of inserting holes 4112 penetrating longitudinally, and the inserting holes 4112 are transversely arranged at equal intervals. The slider 12 is arranged on the guide rail 4111 and is slidably connected with the guide rail 4111. The fixing holder 4110 is hinged with the adjusting end of the adjusting rod 11. The driving member is used to control the slider 12 to move on the guide rail, and includes the lead screw 31 and the driving motor 32. The rotating plate 4140 is arranged below the fixing holder 4110, and an outer side of the rotating plate 4140 is rotatably connected with the fixing holder 4110 through a connecting shaft. Preferably, the rotating plate 4140 is an arc plate, and a distance between the outer side of the rotating plate 4140 and the fixing holder 4110 is smaller than a distance between an inner side of the rotating plate 4140 and the fixing holder 4110. The inner side of the rotating plate is located in a direction where the rotating plate 4140 extends toward one side of the fixing holder 4110, and the outer side of the rotating plate is located in a direction where the rotating plate 4140 extends away from the fixing holder 4110. The plurality of blocking members are arranged in one-to-one correspondence with the plurality of inserting holes 4112, and the blocking members include a blocking rod 4151 and a hinge rod. The blocking rod 4151 is arranged in the inserting holes 4112 and is in sliding contact with the inner walls of the inserting holes 4112. A first end of the hinge rod is hinged with the bottom of the blocking rod 4151, and a second end of the hinge rod is hinged with the inner side of the rotating plate 4140. The torsion spring 4170 is sleeved on the connecting shaft, a first end of the torsion spring 4170 is fixedly connected with the fixing holder 4110, and a second end of the torsion spring 4170 is fixedly connected with the rotating plate 4140, therefore, the torsion spring 4170 enables the inner side of the rotating plate 4140 to tend to approach the fixing holder 4110. In an initial state, all the blocking rods 4151 protrude from the inserting holes 4112 under the action of the torsion spring 4170, and the slider 12 is in contact with one of the blocking rods 4151. When the amplitude of the piston needs to be adjusted, the user lifts the outer side of the rotating plate 4140 upward, under the action of the connecting shaft, the inner side of the rotating plate 4140 pulls down all the blocking rods 4151 through the hinge rod until all the blocking rods 4151 are hidden in the corresponding inserting holes 4112. Then, the user controls the driving member to start, and the driving member 30 controls slider 12 to move. Subsequently, the user releases the rotating plate 4140, under the action of the torsion spring 4170, the inner side of the rotating plate 4140 pushes the inserting rod upward through the hinge rod, when the slider 12 contacts with a next blocking rod 4151, the driving member stops operation, and the slider 12 accurately moves from the position of one blocking rod to the position of the next blocking rod 4151 at a specified distance, under the transmission function of the adjusting rod 11, the amplitude of the piston is adjusted accurately, therefore, when the amplitude increases or decreases every time, the corresponding blocking rod can be used as the positioning point of each gear 4151, so that the spacing of each adjustment is identical, for example, when an amplitude control button is integrated on the fascia gun to control the amplitude adjustment, and the button is pressed every time, the slider 12 moves forward or backward at a constant spacing through a shift-up or shift-down signal, and the constant spacing is the spacing between two adjacent blocking rods 4151. Specifically, the number of adjustment gears can be correspondingly adjusted by changing the number of blocking rods 4151 and spacing. The lead screw 4131 transversely passes through the slider 12, and both ends of the lead screw 4131 are rotatably connected with the fixing holder 4110, and the lead screw 4131 is in threaded connection with the slider 12. The driving motor 4132 is fixedly mounted on the fixing holder 4110, and is electrically connected with the controller for driving the lead screw 4131 to rotate.

In the adjusting structure of the lead screw, because there is a gap between the lead screw and a surrounding supporting structure, after long-term use, the accumulated error of the position of the surrounding supporting structure on the lead screw increases, that is, the actual position of the surrounding supporting structure is inconsistent with a theoretical position, which leads to deviation between an actual amplitude and a theoretical amplitude, consequently, inaccurate amplitude adjustment will be fed back to the user, and the fascia gun cannot provide an accurate massage effect. In order to solve this problem, a magnetic sensor 455 can be used to sense a magnetic member, so as to get the current position of the slider, and calculate the current actual amplitude based on the position of the slider, the actual amplitude is compared with the theoretical amplitude currently corresponding to the adjusting mechanism, and the theoretical amplitude is corrected, thereby correcting the amplitude adjustment error caused by the adjusting mechanism or the driving mechanism, and improving the amplitude control accuracy and massage effect of the fascia gun. FIG. 45 is a schematic diagram showing the arrangement position of the magnetic sensor 455. The magnetic sensor 455 is used to detect the magnetic field strength or magnetic field direction of the magnetic member 4522 to acquire the position information of the slider 12. The control main board is electrically connected with the magnetic sensor 455 and in real time acquires the position information of the slider 12. In addition, the control main board controls the start and stop of the adjusting motor 4531 based on the position information of the slider 12. The magnetic member 4522 is arranged on the slider 12. Theoretically, the magnetic sensor 455 is mounted at any position near the slider 12, in view of the limited inner space of the fascia gun, the magnetic sensor 455 can be mounted on the detection circuit board 4551 of the motor fixing stand 17, and the detection circuit board 4551 is electrically connected with the control main board. The detection circuit board 4551 is used for fixing the magnetic sensor 455, supplying power for the magnetic sensor, and transmitting information to the control main board. The detection circuit board 4551 may be arranged at one end of the motor fixing stand 17 and located on the moving path of the slider 12. During the amplitude adjustment, the magnetic sensor 455 is used to sense the magnetic member 4522, so as to get the current position of the slider 12, and calculate the current actual amplitude based on the position of the slider 12, the actual amplitude is compared with the theoretical amplitude currently corresponding to the adjusting mechanism, and the theoretical amplitude is corrected, thereby correcting the amplitude adjustment error caused by the adjusting mechanism or the driving mechanism, and improving the amplitude control accuracy and massage effect of the fascia gun; in addition, the system can convert the actual amplitude determined according to the position of the slider 12 into a display signal and send the signal to the display module of the fascia gun, so as to display the real-time amplitude and help the user to adjust the amplitude intuitively; moreover, the magnetic sensor 455 can be used to get the real-time position of the slider 12, and can also control the driving mechanism to stop or reverse when the slider 12 is about to reach its moving limit position, so as to avoid structural damage or mechanical failure caused by the slider 12 exceeding the moving range, and increase the safety of amplitude adjustment.

In the above embodiment, the motor or other driving mechanisms connected to the lead screw can be directly controlled by touching, pressing buttons, rotating knobs or other forms to control the signal input; it can also be used in non-screw-driven mechanisms to control the power input; meanwhile, the position movement of the adjusting end can also be directly realized by rotating, pressing and other action forms.

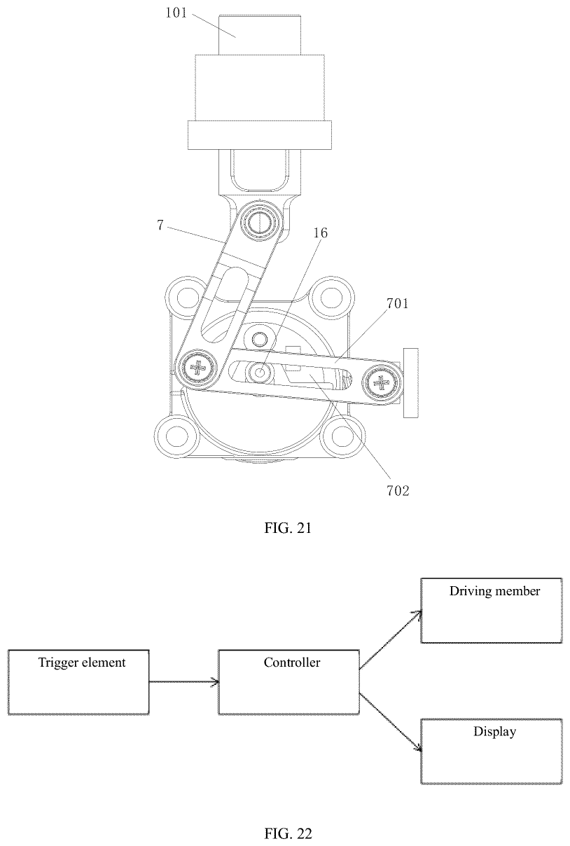

As the deformation structure of the amplitude adjusting mechanism, as shown in FIG. 21, it is an embodiment where the amplitude adjustment is implemented by changing the lever fulcrum. One end of the connecting rod 7 is hinged with the piston 101, and the other end of the connecting rod 7 is hinged with the left end of the support arm 701. An adjusting chute 702 is arranged in the support arm 701, and the output shaft of the eccentric wheel 16 is slidably arranged in the adjusting chute 702. During actual adjustment, the position of the right end of the support arm 701 is adjusted, so that the position of the output shaft of the eccentric wheel 16 in the adjusting chute 702 is changed, the swinging range of the connecting rod 7 is further changed, and the amplitude adjustment of the piston 101 is realized.

In addition to the above embodiments, the amplitude adjustment can also be further performed by changing the eccentric distance. As an alternative technical solution, the structural mode of changing the eccentric distance instead of swinging a linkage mechanism to adjust the amplitude is suitable for a fascia gun with a small volume. A specific way to implement the amplitude adjustment is as follows:

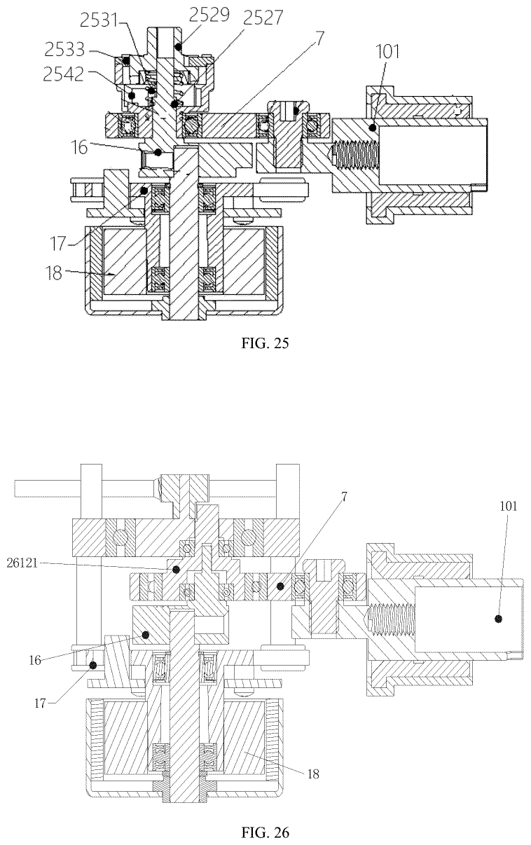

FIG. 25 shows an embodiment where the eccentric distance is adjusted by pressing. A linkage relationship between the pressing rod 2529 and the eccentric sleeve 2542 is constructed, so that the up-and-down movement when the pressing rod 2529 is pressed is converted into the rotation of the eccentric sleeve 2542 around the output shaft of the eccentric wheel 16. Meanwhile, the eccentric sleeve 2542 is sleeved on the output shaft of the eccentric wheel 16, because the outer ring of the eccentric sleeve and the inner ring of the eccentric sleeve are eccentrically arranged on the eccentric sleeve 2542, when the eccentric sleeve 2542 rotates around the output shaft of the eccentric wheel 16 (namely, around the axis of the inner ring of the eccentric sleeve), the spacing between the geometric central axis corresponding to the outer ring of the eccentric sleeve and the motor output shaft of the motor 18 will be changed, thus realizing the amplitude adjustment. Such structural design greatly reduces the required layout space of the amplitude adjusting mechanism.

FIG. 26 shows an embodiment where the eccentric distance is changed through gear transmission. An eccentric adjusting wheel 26121 is sleeved on the output shaft of the existing eccentric wheel 16, and the periphery of the adjusting wheel 26121 is hinged with one end of the connecting rod 7 through a bearing, and the eccentric distance is finally adjusted by rotating the adjusting wheel 26121. Specifically, the adjusting wheel 26121 rotates around the output shaft of the eccentric wheel 16, because the adjusting wheel 26121 has an eccentric structure, the adjusting wheel 26121 will change the swinging range of the connecting rod 7 after rotation, thereby realizing the amplitude adjustment.

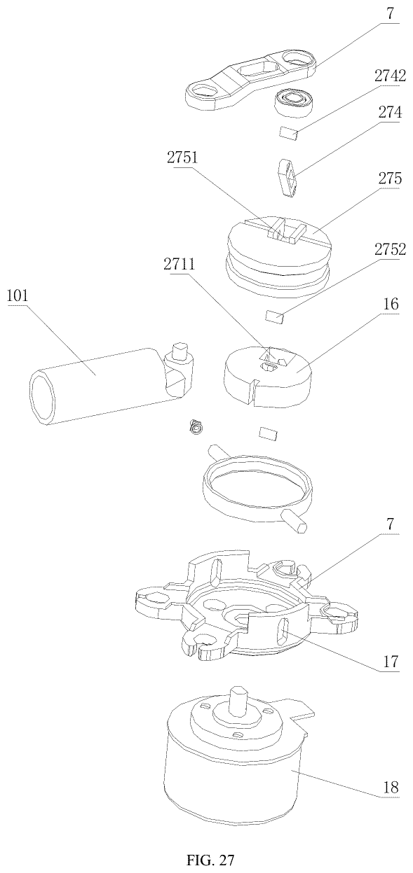

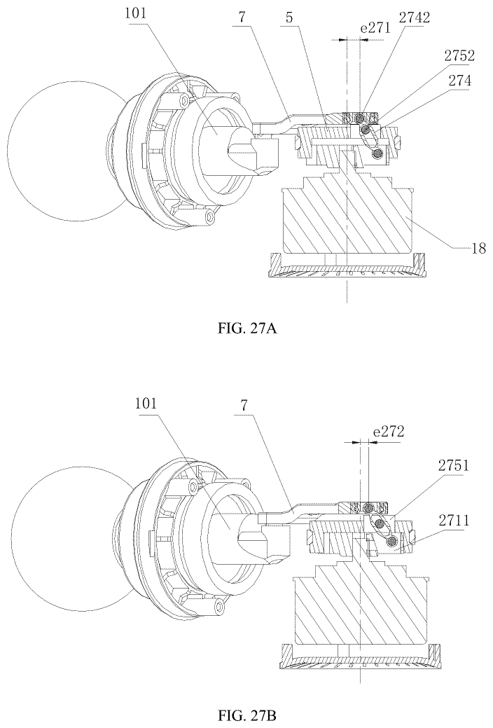

In addition, FIG. 27 shows an embodiment of amplitude adjustment by changing an eccentric distance through a lever. The adjusting rod 274 and the adjusting slider 275 are provided, the connecting rod 7 is connected with the eccentric wheel 16 through the adjusting rod 274, one end of the adjusting rod 274 is hinged with the eccentric wheel 16 through a first rotating shaft, the other end of the adjusting rod 274 is hinged with the connecting rod 7 through a second rotating shaft 2742, and the first rotating shaft is parallel to the second rotating shaft 2742, and the adjusting slider 275 can slide and be fixed in relation to the eccentric wheel 16, and can drive the adjusting rod 274 to rotate around the first rotating shaft when sliding, so that the second rotating shaft 2742 approaches or departs from the rotation axis of the eccentric wheel 16. In a conventional reciprocating transmission mechanism, the eccentric wheel 16 is driven to rotate by the motor, and the eccentric wheel 16 drives the piston rod 101 to move back and forth through the connecting rod 7, because the sizes and relative positions of the parts are constant, the amplitude of the piston rod 101 will not be changed. After the adjusting rod 274 and the adjustment slider 275 are additionally provided in the solution, the adjustment rod 274 and the eccentric wheel 16 form an integral structure, and the eccentric wheel 16 will drive the adjusting rod 274 to rotate, and then the adjusting rod 274 will drive the piston rod 101 to move back and forth through the connecting rod 7. Since the position of the adjusting rod 274 can change with the movement of the adjusting slider 275, the amplitude of the piston rod 101 will be changed. It can be seen from comparison of FIG. 27A and FIG. 27B that the eccentric distance e272 is obviously smaller than the eccentric distance e271 in FIG. 1.

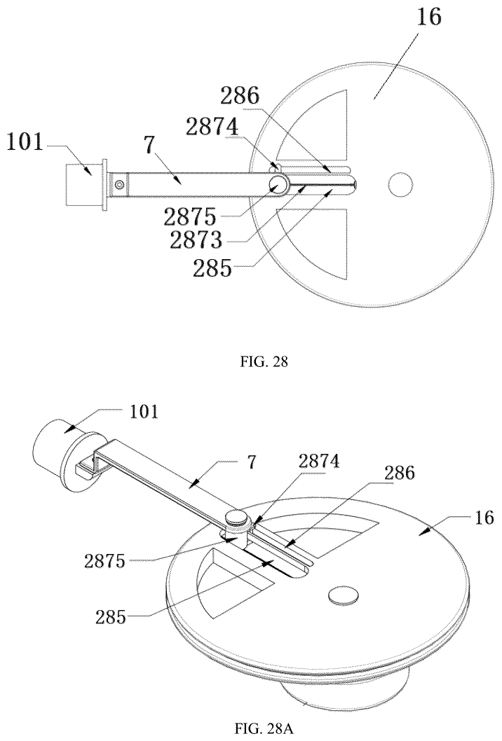

FIG. 28 shows where the eccentric distance is changed through electric adjustment. When the amplitude of the piston 101 is adjusted, the lead screw 2873 is rotated by starting the micro motor, and the rotation of the lead screw 2873 causes the guide block 2875 to horizontally move along the inner wall of the first guide groove 285 in a case that the bottom of the slider 2874 is limited by the chute and the second guide groove 286, so that the guide block 2875 approaches the rotation center of the eccentric wheel 16 and the adjusting rod 2876 pulls the piston 101, to pull the position of the piston 101 and shorten the distance of the relative rotation between the piston and the connecting rod 7, so as to achieve the effect of adjusting eccentric distance, and the amplitude of the piston 101 can be adjusted, the adjustment way is simple and can avoid a problem of changing the eccentric wheel to adjust the eccentric distance and then adjust the amplitude of the fascia gun, it is unnecessary to change the eccentric wheel to adjust the eccentric distance, thus reducing the cost of changing the eccentric wheel.

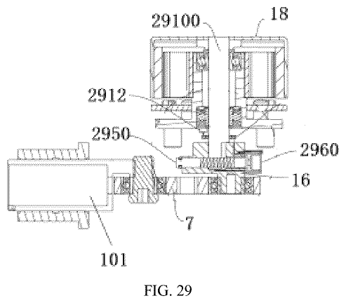

FIG. 29 shows another embodiment where the eccentric distance is changed through electric adjustment. The output shaft 29100 of the motor 18 is in clearance fit with the eccentric wheel 16, and both they are connected by the connecting member 2950, the output shaft 29100 of the motor 18 is screwed with the connecting member 2950, so that there is a gap to implement relative displacement between the output shaft 29100 of the motor 18 and the eccentric wheel 16, and the relative displacement can be implemented by rotating the connecting member 2950. One side of the eccentric wheel 16 is provided with the driving member 2960 for driving the connecting member 2950 to rotate, where the connecting member 2950 can be driven to rotate by the micro motor in the driving member 2960, so that the eccentric wheel 16 is displaced, and the distance between the output shaft 29100 of the motor 18 and the eccentric shaft on the eccentric wheel 16 is changed, the eccentric distance of the eccentric wheel 16 can be quickly adjusted and the amplitude of the vibration driving structure can be adjusted.

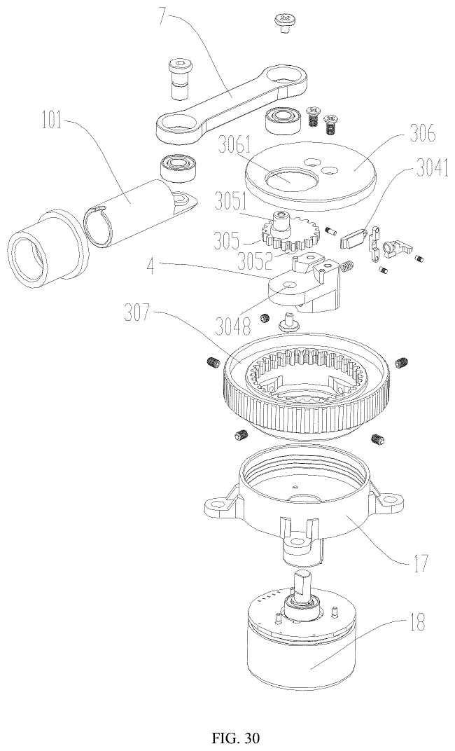

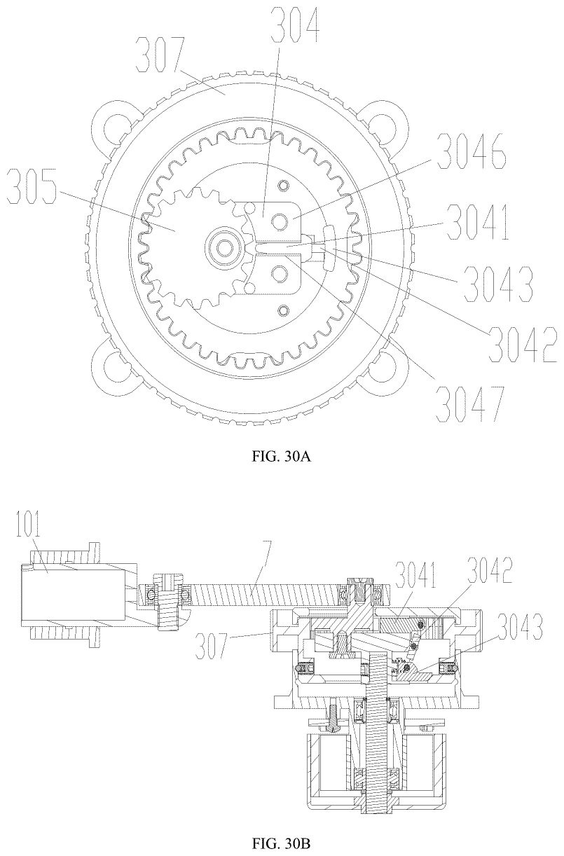

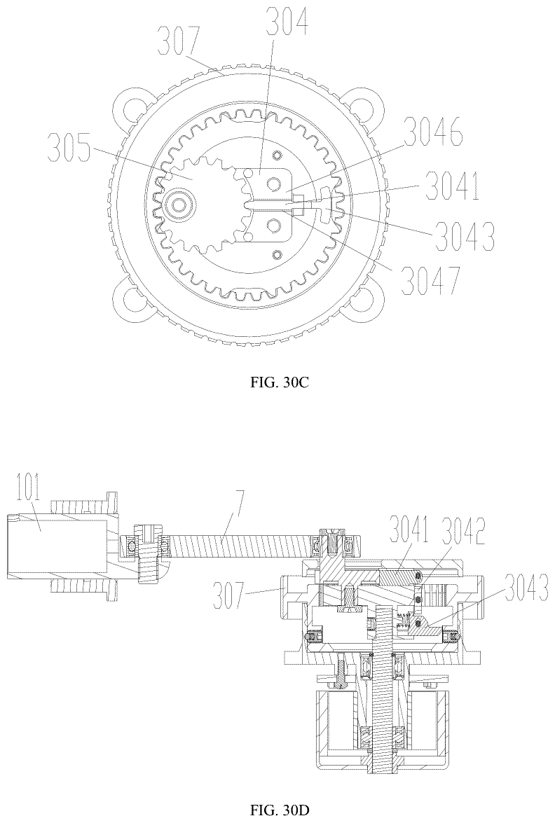

FIG. 30 shows an embodiment where amplitude adjustment is implemented by rotating a planet wheel to adjust the eccentric distance. The piston 101 and the connecting rod 7 are provided, where one end of the swinging arm 7 is hinged with the piston 101, the piston 101 is slidably arranged in a piston sleeve, and the other end of the connecting rod 7 is rotatably connected with the output shaft 3051 of the planet wheel through the bearing of the swinging arm. The cover plate 306 is arranged on the planet wheel 305, and the output shaft 3051 of the planet wheel passes through the cover plate hole 3061 and is connected with the connecting rod 7. The input shaft 3052 of the planet wheel is rotatably arranged in the output hole 3048 of the eccentric wheel, so as to ensure that the input shaft 3052 of the planet wheel is coaxially arranged with the output hole 3048 of the eccentric wheel, in addition, to ensure the normal rotation of the planet gear 305, the input shaft 3052 of the planet wheel is coaxially arranged with the central axis of the planet wheel 305. The input shaft of the eccentric wheel is coaxially arranged with the output shaft of the motor 18, and serves as the power input source for the rotation of the whole eccentric wheel 16. In actual operation, the output shaft of the motor 18 drives the input shaft of the eccentric wheel to rotate, and then drives the input shaft 3052 of the planet wheel to move together through the output hole 3048 of the planet wheel. In the above operation, it is necessary to ensure that the input shaft 3052 of the planet wheel and the output hole 3048 of the eccentric wheel are fixed, that is, to ensure the spacing between the output shaft 3051 of the planet wheel and the input shaft of the eccentric wheel. In other words, this is also the basis of the constant eccentric distance. In the embodiment, the above-mentioned fixing effect is achieved through the arrangement of the inserting rod 3041. One end of the inserting rod 3041 being arranged between two adjacent wheel teeth on the planet wheel 305 causes the planet gear 305 not to rotate, so that the distance (eccentric distance) between the output shaft of the planet wheel 3051 and the input shaft of the eccentric wheel is stable. However, when the eccentric distance needs to be adjusted, one end of the inserting rod 3041 only needs to be pulled out of two adjacent wheel teeth on the planet wheel 305. In this case, the planet wheel 305 is in a rotatable state. When the planet wheel 305 is rotated around the input shaft 3052 of the planet wheel, and the output shaft 3051 of the planet wheel rotates around the input shaft 52 of the planet wheel, so that the spacing between the output shaft 3051 of the planet wheel and the input shaft of the eccentric wheel is changed, and the corresponding eccentric distance is changed, and finally the sliding amplitude of the piston 101 is driven to be adjusted. As shown in FIG. 30A and FIG. 30B, when the inserting rod 3041 is in an unlocking state, the inserting rod 3041 is located in a right position, and the planet wheel 305 can be rotated to implement adjustment. As shown in FIG. 30C and FIG. 30D, when the inserting rod 3041 moves to the left and locks the planet wheel 305, the inserting rod is in a locking state, and the planet wheel 305 cannot rotate.

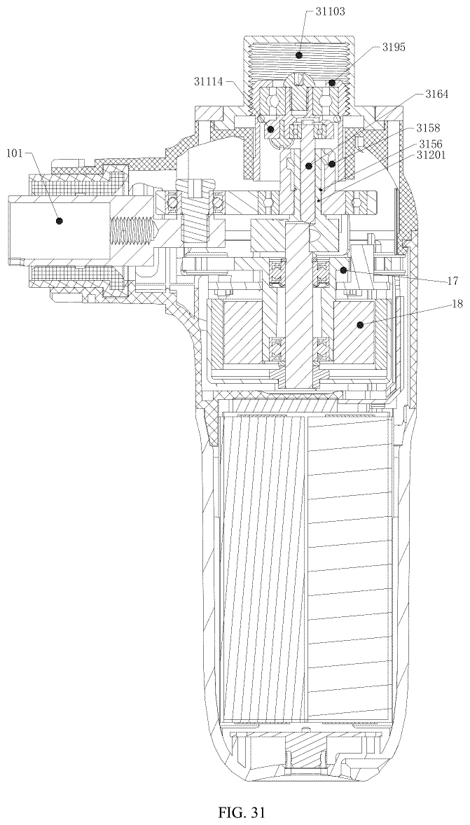

Similar to the above-mentioned rotation mode to change the amplitude, FIG. 31 shows an embodiment of amplitude adjustment by changing the eccentric distance through a knob. When the rotating sleeve 31103 rotates, the screw thread on the rotating sleeve 31103 drives the driving sleeve 3195 to move upward. In this case, due to the limiting effect of the trim of the driving sleeve, the rotating sleeve 31103 does not rotate, but only moves upward. The driving rod 3164 is driven to move upward by the bearing of the fixing shaft, the connecting sleeve 31114 and the bearing of the driving rod. The projection of the driving rod 3164 moves upward when limited by the clamping groove in the eccentric output shaft 31201. The projection is located in the spiral groove in the eccentric ring 3158, and the eccentric ring 3158 is limited on the eccentric shaft 31201 by the steel wire retaining ring 3156 and cannot move axially but can only rotate. Under the action of the spiral groove 31306, the eccentric ring 3158 rotates around the eccentric output shaft 31201, and one end of the eccentric ring 3158 has an eccentric hole, so that the spacing between the output shaft of the motor and the geometric central axis of the eccentric bottom ring can be changed, then the eccentric distance can be changed, and the amplitude of the fascia gun can be changed accordingly.

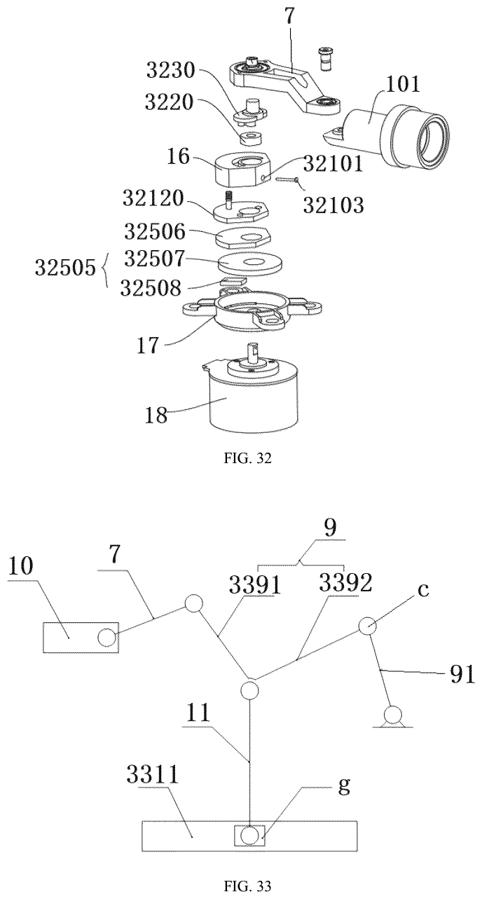

FIG. 32 shows an embodiment where amplitude adjustment is implemented through forward rotation and reverse rotation of the motor according to the rotation characteristics of the motor. The eccentric wheel 16, the rotating bearing 3220, the rotating shaft 3230 and the motor fixing stand 17 are provided; the eccentric wheel 16, the rotating bearing 3220 and the rotating shaft 3230 are cooperatively arranged in the motor fixing stand 17; the eccentric wheel 16 is provided with a bearing hole and a rotating fixing groove, the rotating fixing groove penetrates through the eccentric wheel 16, and the rotating bearing 3220 is mounted in the bearing hole of the eccentric wheel 16. The rotating shaft 3230 includes an eccentric shaft, a lower mounting post, a guide post and a shaft disc, where the eccentric shaft is arranged above the shaft disc, the lower mounting post and the guide post are arranged below the shaft disc, and the lower mounting post and the guide post are located on different axes with the eccentric shaft, the lower mounting post is inserted into the rotating bearing 3220, the guide post is inserted into the rotating fixing groove, and the guide post can rotate around the lower mounting post along the rotating fixing groove. A limit plate 32120 is arranged at the bottom of the eccentric wheel 16 and provided with two limit notches fitting with the two ends of the rotating fixing groove, the limit notches are used for limiting the rotation of the guide post along the rotating fixing groove, a mounting notch is arranged at the bottom of the eccentric wheel 16 and internally provided with an inserting notch, an inserting rod that is in sliding fit with the inserting notch is arranged on the limit plate, and the tension spring is sleeved on the outer side of the inserting rod and arranged in the mounting groove, one end of the tension spring is connected with the eccentric wheel 16, and the other end thereof is connected with the limit plate. When the tension spring is in an unstretched state, the limit plate is attached to the bottom of the eccentric wheel 16, and the inserting rod is inserted into the inserting groove, the motor fixing stand 17 is fitted with a separation component for separating the limit plate 32120 from the eccentric wheel 16. When the eccentric distance needs to be adjusted, the limit plate is separated from the eccentric wheel 16 through the separation component, in this case, the tension spring is stretched and the inserting rod slides in the inserting notch, so that the limit notch cannot limit the guide post, and the guide post is rotated to the other end of the rotating fixing groove to adjust the eccentric distance. After such adjustment is completed, the separation component is released, and the limit plate is restored to the position before separation under the rebound and guidance of the tension spring and the inserting rod, so that the guide post is again fixed by the limit notch. In addition, an electrically controlled separation component is provided in the embodiment and includes an electromagnetic suction part 32505 that can be electrified to generate a magnetic force and a supporting suction part 32506 fitting with the electromagnetic suction part 32505. The electromagnetic suction part 32505 is arranged on the mounting holder, and the supporting suction part 32506 is arranged at the bottom of the limit plate. The electromagnetic suction part 32505 includes an electromagnet 32507 and a controller 32508, the electromagnet 32507 is arranged in the mounting holder, the controller 32508 is configured to control the electromagnet 32507 to be powered on or off, and the supporting suction part 32506 is a metal plate. In use, the electromagnet 32507 can be controlled to be powered on or off by the controller 32508, by which the electromagnet 32507 can suck or release the supporting suction part 32506 to suck or release the limit plate 32120, by this way, the limit notch of the limit plate 32120 can limit the guide post to slide in the rotating fixing groove when the limit plate 32120 is released, when the limit plate 32120 is sucked, the guide post is not limited to slide in the rotating fixing groove.

In addition to the above-mentioned way of changing the eccentric distance to adjust the amplitude, the following adjusting way of the included angle can also be used to change the amplitude. FIG. 35 is a structural schematic diagram showing amplitude adjustment through included angle adjustment. The slider-crank mechanism composed of the output rod 9, the connecting rod 7 and the slider 10 that are hinged in sequence, and the angle adjusting mechanism are provided, where the angle adjusting mechanism includes a crank fixing member 354 and a slider guide member 355 that are hinged with each other, the hinge axis of the crank fixing member 354 and the slider guide member 355 is parallel to the axis of the rotation center of the output rod 9, but they are not located in a same axis, the rotation center of the output rod 9 is fixed on the crank fixing member 354, and the slider 10 is slidably arranged on the guide member 355 of the slider. The adjustment principle of the transmission mechanism is that: the rotation center of the output rod 9 deviates from the guide center line of the slider 10 by fixing the crank fixing member 344 and rotating the guide member 345 of the slider, or fixing the guide member 345 of the slider and rotating the crank fixing member 344, or rotating the crank fixing member 344 and the guide member 345 of the slider, so that the conventional centering slider-crank mechanism is changed into an offset slider-crank mechanism with an adjustable offset distance. The guide center line refers to a straight line that passes through the center of the slider and is parallel to the reciprocating path of the slider. The offset distance is the distance from the rotation center of the output rod 9 to the guide center line where the slider 10 moves, and e35 is the offset distance. When the offset distance is changed, the sliding range of the slider 10 on its guide center line will be changed, this also leads to the change in the amplitude of the slider 10. The locking mechanism 356 is connected between the crank fixing member 354 and the guide member 355 of the slider to fix the relative positions of the crank fixing member 354 and the guide member 355 of the slider. When the amplitude is adjusted to an appropriate value, the locking mechanism 356 can be used to fix the crank fixing member 354 and the guide member 355 of the slider, so as to prevent the amplitude from changing during operation. The locking mechanism 356 can have various structural forms, such as locking the rotating pair of the crank fixing member 354 and the guide member 355 of the slider with bolts and nuts, connecting and fixing the crank fixing member 354 and the guide member 355 of the slider with connectors, or fixing the crank fixing member 354 or the guide member 355 of the slider to an external fixing member with connectors.

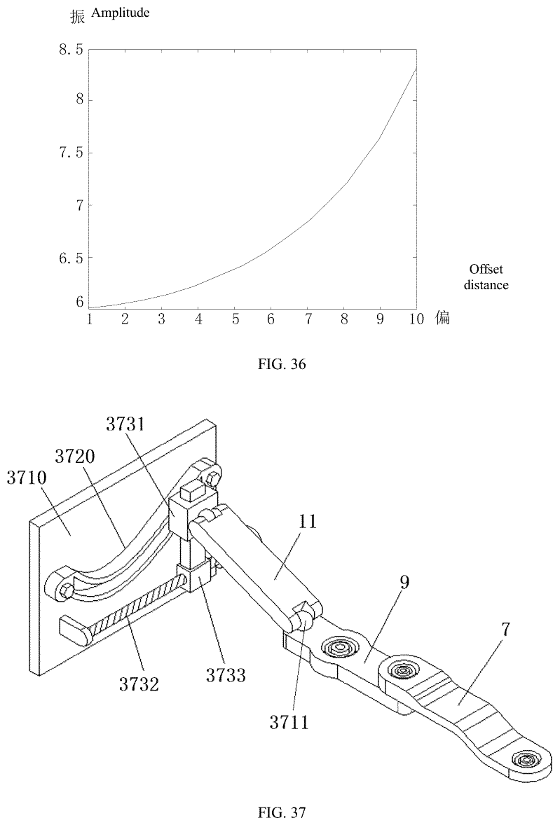

FIG. 36 is a function relationship diagram showing an offset distance and amplitude of an amplitude adjusting structure shown in FIG. 35. Currently, most fascia guns with variable amplitudes have not a function of displaying an amplitude in real time, resulting in that users can only adjust an amplitude by hitting when using a fascia gun and are unable to exercise accurate control over the amplitude. An amplitude and an offset distance of a fascia gun are indicated on the display panel of the fascia gun, so that users can select and understand the current amplitude in an intuitive manner. Here, two display modes are provided, one of which is realized by software and another of which is realized by a hardware structure. When software is used to display, first, a function relationship between an offset distance e35 and an amplitude is invoked, then a corresponding amplitude is determined based on the current offset distance e35 and the function relationship, finally, the current offset distance e35 or/and the amplitude is indicated on the display panel of the fascia gun. Specifically, in a fascia gun, a supporting metering module is needed to record a change in an offset distance and a controlling module is needed to invoke a function relationship. In this way, an amplitude can be obtained according to a corresponding function relationship and displayed on a display panel. Specifically, the metering module may be a displacement sensor or an angle sensor, or the like. A different offset distance invoking way corresponds to a different function relationship, therefore, a corresponding function relationship needs to be invoked. When a hardware structure is used to implement display, two display modes are designed in the invention: shifting and turning the center of gyration of a crank. When an offset distance is adjusted by shifting the center of gyration, a scale line is set parallel to the Y axis on the housing of the fascia gun, and a pointer pointing the scale line set on the center of gyration of the crank is used to indicate the offset distance and/or amplitude. When an offset distance is adjusted by turning the center of gyration of a crank, a dial plate coaxial with the rotation center is provided on the housing of the fascia gun, and a pointer that can rotate around the center of the dial plate and is connected to the center of gyration of the crank is used to indicate an offset distance or/and an amplitude. That the pointer is connected to the center of gyration of the crank means that the pointer moves with the center of gyration of the crank, but will not rotate with the crank. When a hardware structure is used to implement display, a corresponding offset distance or/and amplitude needs to be marked on the scale line or dial plate in advance based on an indicating position of the pointer. The pointer moves as a position of the center of gyration of a crank is adjusted and points to different positions on the scale line or dial plate, intuitively displaying the current offset distance or/and amplitude. Certainly, display may be implemented by fixing the pointer, moving the scale line or turning the dial plate.

Additionally, FIG. 47 provides another solution to adjust an amplitude, that is, a solution to adjust the amplitude by way of a drive surface. As shown in FIG. 47, a driving member 470, a transmission member 47120, an output member 47130 and an adjusting member 4742 are provided. The transmission member 47120 is connected to the driving member 470 that is used to drive the transmission member 47120 to rotate and the transmission member 47120 has a drive surface 47121B arranged at an included angle with a rotation axis thereof. The output member 47130 is used to match the drive surface 47121B of the transmission member 47120, so that the drive surface 47121B of the transmission member 47120 can drive the output member 47130 to perform reciprocating motions. The adjusting member 4742 is connected to the transmission member 47120 and is used to adjust an angle between the drive surface 47121B of the transmission member 47120 and the rotation axis of the transmission member 47120, to adjust an amplitude of the output member 47130. As the transmission member 47120 has the drive surface 47121B that is arranged at an included angle with the rotation axis thereof, when the transmission member 47120 rotates around its rotation axis, the drive surface 47121B fluctuates reciprocally. The adjusting member 4742, fitted together with the drive surface 47121B, can make the adjusting member 4742 fluctuate with the drive surface 47121B and extend and retract in a reciprocating manner. A stand is usually arranged during use, and the body of the output member 47131 can only slide in the telescopic direction under constraint of the stand. In this way, the output member 47130 will not rotate around its own axis under an action of the drive surface 47121B, but only extend and retract in the telescopic direction, implementing reciprocating motions in a proper way. The output member 47130 is slidably connected with the stand in a plurality of ways, and usually, by means of a sliding rail and a chute. Meanwhile, the driving member 470, the adjusting member 4742, and other components are installed on the stand which provides positioning and support for them. An inclination angle between the drive surface 47121B and a rotation axis of the transmission member 47120 affects the amplitude. In related art, an inclination angle between the drive surface 47121B and a rotation axis of the moving component remains unchanged so that the amplitude in the related art is not adjustable. Therefore, the adjusting member 4742 is provided in this application, to adjust the angle between the drive surface 47121B and the rotation axis of the transmission member 47120, to change a range of fluctuation of the drive surface 47121B during a rotation of the transmission member 47120. In addition, the amplitude of a reciprocating motion of the output member 47130 is further changed by fitting of the output member 47130 and the drive surface 47121B. The drive surface 47121B generates two opposite thrust forces for the output member 47130 to extend and retract circularly and the drive surface 47121B has advantages of uniform and continuous force transmission. In this application, provision of the drive surface 47121B helps to ensure smooth reciprocating motions in this application, reduce noise generated during a motion, reduce an overall volume of a mechanism and extend service life of the mechanism. In addition, design of the adjusting member 4742 in this application makes an amplitude adjustable. In this way, a user, when using this application, can make an adaptive adjustment according to different scenarios and working conditions, facilitating the use of this application which can be used in a variety of scenarios. In this application, the angle between the drive surface 47121B and the rotation axis of the transmission member 47120 is adjusted to adjust the amplitude. Continuous adjustments can be made on the angle, providing a more diverse amplitude adjustment interval for this application, even continuous amplitude adjustment can be realized, which is applicable to more application scenarios. Besides, a simpler amplitude adjustment mode is provided in this application. The transmission member 47120 includes a turning disc 47121 and a first connecting member 47122, where the turning disc 47121 is rotatably connected to the first connecting member 47122 that is in driving connection with the driving member 470. The drive surface 47121B is of two sides of the turning disc 47121 along the rotation axis, and the turning disc 47121 is rotatably connected to the adjusting member 4742. The drive surface 47121B is set on the turning disc 47121 rotatably connected to the first connecting member 47122 that is in driving connection with the driving member 470. The rotation axis of the transmission member 47120 is the rotation axis of the first connecting member 47122. When the adjusting member 470 drives the turning disc 47121 to rotate along the first connecting member 47122 for a certain angle, the turning disc 47121 drives the drive surface 47121B to rotate together, which is changed the angle between the drive surface 47121B and the rotation axis. Additionally, when the drive surface 47121B is driven by the first connecting member 47122 to rotate, a fluctuation range of the drive surface 47121B is changed, thereby adjusting the amplitude. A way in which the turning disc 47121 drives the drive surface 47121B to adjust is adjusted, facilitating adjustment on an angle of the drive surface 47121B. The transmission member 47120 includes the turning disc 47121 and the first connecting member 47122, and is small in quantity of transmission members and simple in structure. Therefore, the rotatable connection between the turning disc 47121 and the first connecting member 47122 is easily made, which facilitates processing of the transmission member 47120. During a reciprocating motion, two drive surfaces 47121B on the turning disc 121 alternately apply force to the output member 47130, respectively, to make the output member 47130 extend or retract. A connecting part 47121A is provided on the turning disc 47121 for connecting with the adjusting member 470. When the turning disc 47121 rotates around the first connecting member 47122 and the angle of the drive surface 47121B is adjusted, a motion path of the connecting part is curved.

When a fascia gun is used, the parts that need to be massaged are different in different application scenarios and the amplitudes corresponding to different massaged parts need to be adjusted adaptively, so as to improve the comfort and safety of massage. In actual use, the amplitude needs to be adjusted according to application scenarios, physiological parameters and other information. Different amplitude requirements can be implemented based on a collection of a user-related parameter (for example, recovery after massage and identification of a muscle area), or a service status of the fascia gun (for example, type of a massage head and frequency change), or related scenario information input by a user, a plurality of ways for amplitude adjustment have been proposed in the above implementations, and a combination of the amplitude adjustment ways with corresponding scenarios in actual use enhances a therapeutic massage effect.

Solutions for control of amplitude adjustment in combination with related scenarios are as follows:

FIG. 50 shows a solution for adjusting a massage path based on a muscle fiber is provided. FIG. 50 is a comparison diagram of a massage path parallel to a muscle fiber (a) and a massage path perpendicular to a muscle fiber (b). In the invention, a plurality of amplitude variation patterns are preset in a massage device according to a relative relationship between a massage path and a muscle fiber direction, in this way, an amplitude variation pattern of the massage device is selected based on the massage path in practical application. As shown in FIG. 50a, a muscle fiber can be properly combed if a massage path is parallel to a muscle direction, which relaxes the muscle fiber over a wide area, reduces damage to a muscle, relieves muscle pain and promotes muscle recovery. As shown in FIG. 50b, a muscle pain point, a trigger point and a strain point can be properly relieved if a massage path is perpendicular to a muscle direction.

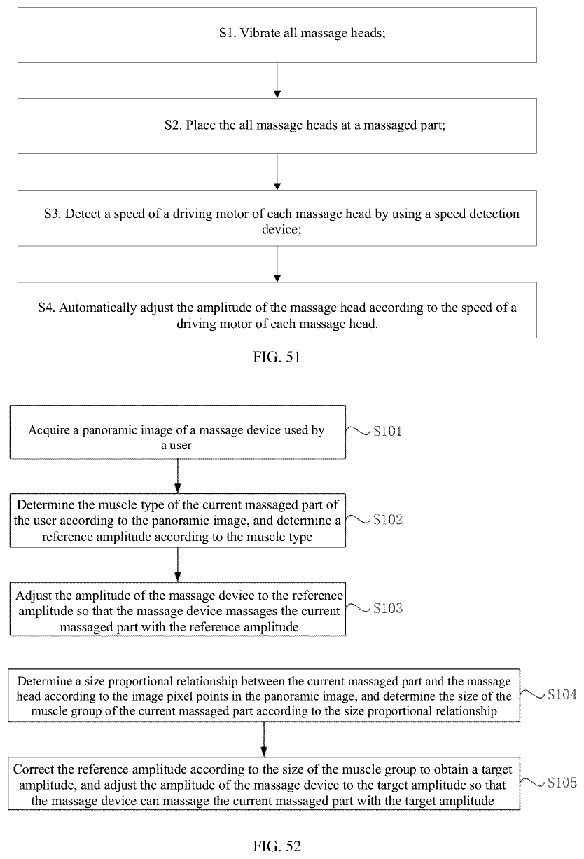

Additionally, sometimes, the fascia gun used has a plurality of massage heads, a fascia gun requiring a plurality of massage heads can adjust its amplitude automatically based on speed of a driving motor, so that strength of each massage head felt by a human body is even. FIG. 51 is a process diagram of adjusting amplitude based on variation of speed of a driving motor of a massage head. The solution makes improvement based on an application scenario in which there are a plurality of massage heads, where the massage heads are connected to a piston 101, including an MCU and N massage heads, and each massage head has its amplitude adjusted by the MCU that automatically controls the motor to drive the extension and retraction according to the massage requirements. Specifically, the N massage heads can be arranged in a dot matrix, a specific arrangement mode of which can be set according to a massage position, with N being a positive integer greater than or equal to 2, forming regular shapes such as a rectangle, a triangle, a rhombus, a straight line, a concentric circle and other regular shapes. A reciprocating drive mechanism of continuously variable amplitude is provided on each massage head, and each massage head of a massage device with a plurality of massage heads has its amplitude adjusted separately, therefore, the invention provides an automatic adjustment method, in which the MCU controls an opening process and a closing process or an amplitude of each massage head in sequence. For a single massage head, before it touches a surface of a human body, speed of a driving motor is constant, when the massage head touches the surface of a human body and apply some pressure thereto, the massage head meets resistance, reducing speed of the driving motor. Now, a magnitude of the resistance encountered can be judged by an amount of speed reduction, so that an amplitude of each massage head is adjusted, and a human body feels even strength from each massage head, which meets a user's massage requirement of even strength from each massage head. The method shown in FIG. 51 is adopted due to that a massage position of a human body is not flat, therefore, a resistance encountered by each massage head is different, resulting in different is changed in the speed of the driving motor of each massage head, in this way, a massage distance of each massage head is judged, so that the MCU automatically adjusts the amplitude of the massage head according to the massage distance.

A most appropriate amplitude can also be matched automatically based on a muscle type, to enable muscle at different positions to have a most appropriate massage. FIG. 52 shows a method for determining a muscle type and a process for amplitude adjustment based on the muscle type. The method includes the following steps: Step 101. Acquire a panoramic image of a user using a massage device: in an embodiment of this application, when the user uses the massage device for massage, a panoramic image of the user using the massage device can be obtained in real time through a camera or a terminal device with a camera, where the panoramic image is an image that includes all human body parts as well as the massage device; in actual application, the user may face the camera squarely and place the camera at a distance from the human body, to enable an image acquired by the camera cover an entire body of the user. When the terminal device is used for acquiring a panoramic view, the terminal device is required to communicate and connect with a controlling module of the massage device. Step 102. Determine the muscle type of the massage position of the user based on the panoramic image and determine a reference amplitude based on the muscle type: in an embodiment of this application, a method for determining the muscle type of the massage position of the user may include: Step 1021. Obtain a human body part of the user in the panoramic image through a human body recognition algorithm and abstract the human body image into a skeleton model containing a plurality of joint points based on the human body obtained: in an embodiment of this application, the controlling module can firstly pre-process the panoramic image received, including operations such as image cropping, resizing, and color space conversion, to facilitate subsequent feature extraction and use; then an object detection algorithm is used, for example, a CNN convolutional neural network is used to perform object detection on the panoramic image, to recognize a human body part of the user in the panoramic image, for example, head, shoulders, arms, waist, and legs; then a feature extraction algorithm is used, for example, Scale-invariant Feature Transform (SIFT), Speeded Up Robust Features (SURF), and Oriented FAST and Rotated BRIEF (ORB), to extract a feature vector from a detected target body part, where the feature vector is used to represent information such as shape, size and location of each human body part; then a skeleton model is built based on the feature vector and a machine learning algorithm, where the machine learning algorithm includes a K Near Neighbor, a Support Vector Machine (SVM), and a Decision Tree; the skeleton model in the embodiment of this application can represent a relative position of and connection relationship between a skeleton structure of the human body, including a skull, a spine, a sternum, a pelvis, an upper limb bone, and a lower limb bone; a graphics technology may also be used in an embodiment of this application, for example, OpenGL and 3D Max, where the skeleton model is rendered into a 3D image and the skeleton model built is visually presented for easy observation and analysis; Step 1022. Determine information about a position of the massage head relative to a joint point and determine a muscle type of the current massage position according to the information about a position of the massage head relative to a joint point: in an embodiment of this application, feature recognition may be implemented for the massage head, to determine information about a position of the current massage head relative to the joint point, to identify a muscle type of the current massage position; for example, when the current massage head is located in a position between the left shoulder and the left elbow, the muscle type of the current massage position is biceps muscle; the above method can be used to quickly and accurately recognize a muscle group of the user that is currently massaged, improve the accuracy of muscle type determination and further improve the accuracy of amplitude adjustment. Step 103. Adjust the amplitude of the massage device to the reference amplitude, to make the massage device massage the current massage position with the reference amplitude: after the reference amplitude has been determined, the controlling module of the massage device can generate a control signal corresponding to the reference amplitude, and sends the control signal to the reciprocating drive mechanism of continuously variable amplitude which adjusts the amplitude of the massage device to the reference amplitude, so that the massage device massages the current massage position with the reference amplitude. Step 104. Determine a size ratio between the current massage position and the massage head according to an image pixel in the panoramic image and determine a size of the muscle group to which the current massage position belongs according to the size ratio: in actual application, the size ratio between the current massage position and the massage head may be calculated by identifying a size of the image pixel of the massage head and a size of the image pixel of the current massage position, so that the size of the muscle group to which the current passaged part belongs is determined; specifically, a larger size ratio between the current massage position and the massage head indicates a larger muscle group to which the current massage position belongs, and a smaller size ratio between the current massage position and the massage head indicates a smaller muscle group to which the current massage position belongs. Step 105. Correct the reference amplitude according to the size of the muscle group to obtain a target amplitude and adjust the amplitude of the massage device to the target amplitude, so that the massage device massages the current massage position with the target amplitude; when the size of the muscle group to which the current massage position belongs is determined, the reference amplitude is corrected according to the size of the muscle group, for example, if there is a large muscle group, the amplitude is increased based on the reference amplitude to obtain the target amplitude; if there is a small muscle group, the amplitude is decreased based on the reference amplitude to obtain the target amplitude; after the target amplitude is determined, the controlling module of the massage device can generate the control signal corresponding to the target amplitude, and sends the control signal to the reciprocating drive mechanism of continuously variable amplitude which adjusts the amplitude of the massage device to the target amplitude, so that the massage device massages the current massage position with the target amplitude; and the reference amplitude is corrected by identifying the size of the muscle group, avoiding an amplitude adaptation error due to an individual difference and further improving accuracy of amplitude adjustment.

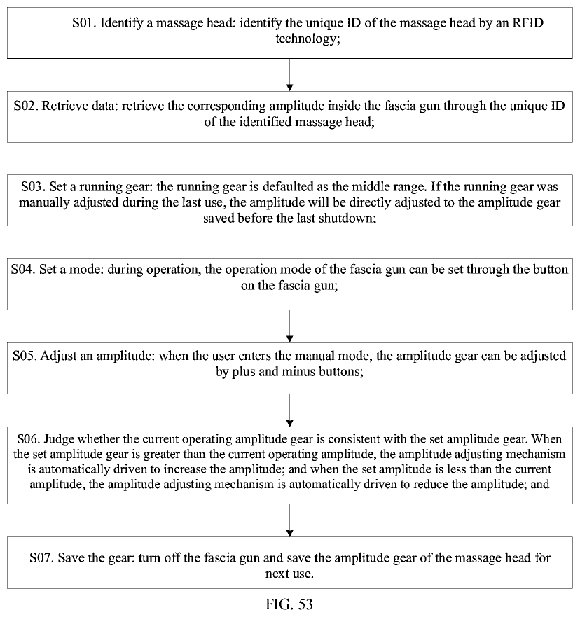

In addition to an optimal amplitude automatically matched according to the muscle type, an appropriate amplitude can also be automatically matched according to a condition of a massage head installed. In this way, a matched amplitude can be obtained only by changing the massage head. In terms of an identification mode of a massage head, a single massage head can be identified based on an insertion depth thereof, where a magnetic sensor, an infrared range finder, and other instruments can be used for the identification. Alternatively, markings in different arrangements, different shapes or in different angles are arranged in the insertion position of the massage head for identification. FIG. 53 shows a method for automatic amplitude adjustment based on massage head identification, the method solves a problem in the prior art that the user cannot obtain good massage experience in use of different types of massage heads due to failure in quickly adjusting a massage head amplitude to an appropriate amplitude. The fascia gun of the embodiment includes a variety of massage heads, the amplitude of each massage head is set to three amplitude gears, and each amplitude gear corresponds to one amplitude and is respectively recorded as high range, middle range and low range, where the amplitude at the high range is greater than the amplitude at the middle range and the amplitude at the middle range is greater than the amplitude at the low range; the amplitudes corresponding to high, middle and low ranges are all within the preset amplitude ranges of the corresponding massage heads, and the fascia gun is provided with a mode setting button and an amplitude gear adjusting button. The mode setting button is used to adjust the operation mode during the operation of the fascia gun, and the operation mode includes an automatic mode and a manual mode, where the automatic mode includes a fixed amplitude mode and a variable amplitude adjustment mode, and the manual mode is that the amplitude of the massage head can be adjusted by the amplitude gear adjusting button. For example, the automatic mode is taken as the fixed amplitude mode, after the user mounts the massage head on the massage head driving member with an adjustable amplitude, the method includes the following steps: S01. Identify a massage head: identify the unique ID of the massage head by an RFID technology. Specifically, the fascia gun can identify the massage head through the unique ID of the massage head. S02. Retrieve data: retrieve the corresponding amplitude inside the fascia gun through the unique ID of the identified massage head. Specifically, the amplitude gear of each massage head, including high range, middle range and low range, is stored in the fascia gun. S03. Set a running gear: the running gear is defaulted as the middle range. If the running gear was manually adjusted during the last use, the amplitude will be directly adjusted to the amplitude gear saved before the last shutdown. Specifically, the running mode of the fascia gun in the embodiment is the automatic mode by default. In the automatic mode, the fascia gun performs a massage at a fixed amplitude gear (namely, the middle amplitude gear by default), and the user can switch modes by clicking the button on the fascia gun to proceed to S04. S04. Set a mode: during operation, the operation mode of the fascia gun can be set through the button on the fascia gun. Specifically, the user is changed the running mode of the fascia gun from the default automatic mode to the manual mode through the mode setting button, and the amplitude of the massage head can be adjusted in the manual mode to proceed to S05. S05. Adjust an amplitude: when the user enters the manual mode, the amplitude gear can be adjusted by plus and minus buttons. Specifically, after entering the manual mode, the fascia gun still performs a massage at a previous amplitude gear before the amplitude gear thereof is adjusted, and the user can manually adjust the amplitude through the amplitude gear adjusting button, where the amplitude gear adjusting button includes the plus and minus buttons. The fascia gun also has a human-computer interaction interface, and the human-computer interaction interface is used to display the current operating amplitude gear and set the amplitude gear, and to prompt the user to suggest the massage position of the installed massage head. S06. Judge whether the current operating amplitude gear is consistent with the set amplitude gear. When the set amplitude gear is greater than the current operating amplitude, the amplitude adjusting mechanism is automatically driven to increase the amplitude; and when the set amplitude is less than the current amplitude, the amplitude adjusting mechanism is automatically driven to reduce the amplitude. Specifically, after the user adjusts the amplitude gear through the corresponding plus and minus buttons, the set amplitude gear is changed, and the fascia gun judges whether the current operating amplitude gear is consistent with the set amplitude gear; when the set amplitude gear is greater than the current amplitude gear, the amplitude adjusting mechanism is automatically driven to increase the amplitude; and when the set amplitude gear is smaller than the current amplitude gear, the amplitude adjusting mechanism is automatically driven to reduce the amplitude reduction. The amplitude adjusting mechanism is the driving unit in this application, and the driving unit is used for adjusting the position of the other end of the amplitude adjusting rod 4 on the limit element 5, thereby adjusting the reciprocating swinging amplitude of the vibration driving rod 3, and further adjusting the amplitude of the massage head. S07. Save the gear: turn off the fascia gun and save the amplitude gear of the massage head for next use. Specifically, the amplitude gear of the massage head adjusted by the user is saved to replace the default amplitude gear in S03; and when the massage head is used next time, the fascia gun performs a massage at the adjusted amplitude gear.

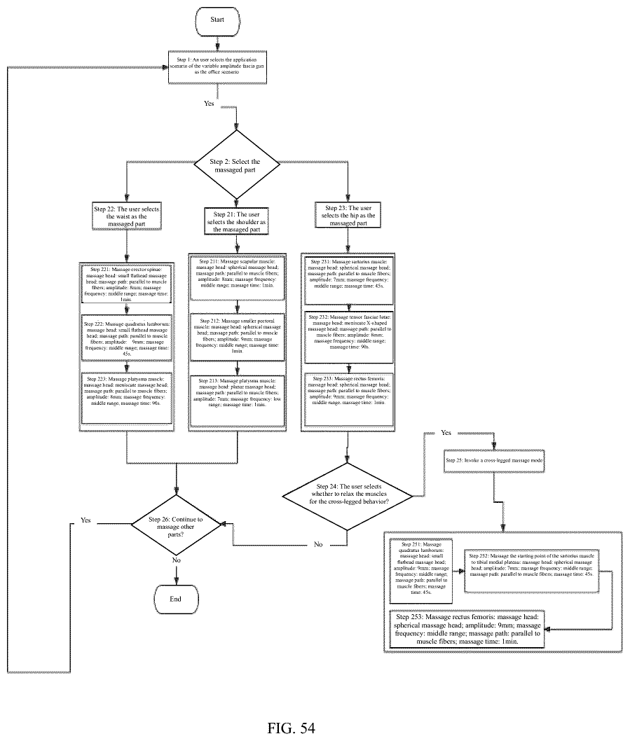

Among the users of fascia gun products, sedentary office users also account for a large proportion. The fascia gun is designed to meet the massage needs of the parts that need to be massaged after sedentary living. FIG. 54 shows a control method based on an office scenario, the method solves a problem that the sedentary office user cannot have a good massage effect due to failure in matching of the massage amplitude with the muscle state in sedentary work when the massage amplitude of the variable amplitude fascia gun is adjusted mainly by such user. In application, the user selects the massaged part after selecting the office scenario, and the variable amplitude fascia gun automatically invokes the amplitude corresponding to the current massaged part for massage, including the following steps: Step 1: The user selects the massage scenario as the office scenario. Step 2: After the user selects the parts to be massaged according to the prompts and their own needs, the variable amplitude fascia gun prompts the user to select the massage head according to the preset muscle massage sequence of each part, and automatically invokes the corresponding parameters including massage amplitude, massage frequency and massage time for operation, and guides the user to move the variable amplitude fascia gun according to the corresponding massage path. If the user selects to massage the shoulder and neck, proceed to Step 21; if the user selects to massage the waist, proceed to Step 22; and if the user selects to massage the hips, proceed to Step 23. Step 21: The user selects to massage the shoulder and neck. Looking down at the screen at the desk in the office is likely to cause neck and shoulder posture problems such as neck stretching and shoulder shrugging. The reason for the problem is the imbalance of muscle strength caused by maintaining the same posture for a long time: muscle weakness and muscle tension. The key factor of muscle strength imbalance is the shortened muscle instead of the lengthened muscle, so the muscles shortened by maintaining the posture should be treated for the first time. The fascia gun guides the user to select the sequence of shoulder muscle massage as scapular muscle-smaller pectoral muscle-platysma muscle. Step 211: When the user selects to massage the scapular muscle, the user is guided to select a spherical massage head, and the variable amplitude fascia gun automatically invokes the amplitude of 8 mm, where the massage frequency is moderate and the massage time is 1 min, and the user is guided to move the fascia gun in the direction parallel to the muscle fiber. Step 212: When the user selects to massage the smaller pectoral muscle, the user is guided to select the spherical massage head, and the variable amplitude fascia gun automatically invokes the amplitude of 9 mm, where the massage frequency is moderate and the massage time is 1 min; and the user is guided to move the fascia gun in the direction parallel to the muscle fiber. Step 213: When the user selects to massage the platysma muscle, the user is guided to select a planar massage head, and the variable amplitude fascia gun automatically invokes the amplitude of 7 mm, where the massage frequency is low and the massage time is 1 min, and the user is guided to move the fascia gun in the direction parallel to the muscle fiber. After the shoulder and the neck are massaged, the user is prompted to judge whether other parts need to continue to be massaged. If the user needs to massage other parts, return to Step 1 to continue to select massaged parts, and if not, end the massage. Step 22: The user selects to massage the back. The posture problem of hunching caused by long-term hunchback work mainly affects muscles such as erector spinae waist, quadratus lumborum and latissimus dorsi. According to the muscle areas and different muscle depth, the fascia gun guides the user to select the massage sequence of waist muscles as erector spinae-quadratus lumborum-latissimus dorsi. Step 221: When the user selects to massage the erector spinae, the user is guided to select a small flathead massage head, and the variable amplitude fascia gun automatically invokes the amplitude of 8 mm, where the massage frequency is moderate and the massage time is 1 min, and the user is guided to move the fascia gun in the direction parallel to the muscle fiber. Step 222: When the user selects to massage the quadratus lumborum, the user is guided to select the small flathead massage head, and the variable amplitude fascia gun automatically invokes the amplitude of 9 mm, where the massage frequency is moderate and the massage time is 45 s; and the user is guided to move the fascia gun in the direction parallel to the muscle fiber. Step 223: When the user selects to massage the platysma muscle, the user is guided to select a meniscate massage head, and the variable amplitude fascia gun automatically invokes the amplitude of 8 mm, where the massage frequency is low and the massage time is 90 s, and the user is guided to move the fascia gun in the direction parallel to the muscle fiber. After the waist is massaged, the user is prompted to judge whether other parts need to continue to be massaged. If the user needs to massage other parts, return to Step 1 to continue to select massaged parts, and if not, end the massage. Step 23: The user selects to massage the hip. The posture problem of anterior tilt of pelvis caused by prolonged sitting and hip flexion mainly affects the muscles including sartorius muscle, tensor fasciae latae and rectus femoris, according to the muscle length, the nature of similar muscle tissues and the different muscle depth, the fascia gun guides the user to select the shoulder massage sequence as sartorius muscle-tensor fascia latae-rectus femoris. Step 231: When the user selects to massage the sartorius muscle, the user is guided to select the spherical massage head, and the variable amplitude fascia gun automatically invokes the amplitude of 7 mm, where the massage frequency is moderate and the massage time is 45 s, and the user is guided to move the fascia gun in the direction parallel to the muscle fiber. Step 232: When the user selects to massage the tensor fasciae latae, the user is guided to select a meniscate massage head, and the variable amplitude fascia gun automatically invokes the amplitude of 8 mm, where the massage frequency is moderate and the massage time is 90 s, and the user is guided to move the fascia gun in the direction parallel to the muscle fiber. Step 233: When the user selects to massage the rectus femoris, the user is guided to select the spherical massage head, and the variable amplitude fascia gun automatically invokes the amplitude of 9 mm, where the massage frequency is moderate and the massage time is 1 min; and the user is guided to move the fascia gun in the direction parallel to the muscle fiber. When the user crosses the legs in a sitting posture with hip flexion, thigh flexors on the upturned side contract more, and the muscles on the same side of the waist that affect the pelvic tilt contract more. In muscle massage, more emphasis is placed on the muscles on the upturned side. After the hip is massaged, the user is prompted to judge whether there is the behavior of crossing the legs, if so, enter the special mode of hip massage in Step 25. The user performs the massage settings for hip relaxation of cross-legged behavior are as follows. Step 251: The user is guided to select the small flathead massage head to massage the quadratus lumborum, where the amplitude of the fascia gun is 9 mm, the massage frequency is moderate and the massage time is 45 s; and the user is guided to move the fascia gun along the direction of the muscle fiber. Step 252: The user is guided to select the spherical massage head to massage the sartorius muscle, where the amplitude of the fascia gun is 7 mm, the massage frequency is moderate and the massage time is 45 s; and the user is guided to slide and hit the legs around the starting and ending points (the starting point is around the anterior superior spine and the ending point is above and below the tibial medial plateau) along the direction of the muscles on the upturned side. Step 253: The user is guided to select the spherical massage head to massage the rectus femoris, where the amplitude of the fascia gun is 9 mm, the massage frequency is moderate and the massage time is 1 min; and the user is guided to slide the leg on the upturned side along the direction of the muscle fiber for unilateral operation. After the massage, if the user needs to massage the other parts, return to Step 1 to continue to select the massaged parts, and if not, end the whole massage process. A control system based on the control method of the variable amplitude fascia gun based on the office scenario includes a user operation interface module, a communication module, a mode preset module and a detection processing module; the user operation interface module includes a massage device start switch and a massaged part selection switch; an intuitive user interface is designed, so that the user can easily operate the fascia gun, and the operation method is easy to understand and execute. The mode preset module is used for storing massage heads, massage amplitudes, massage frequency, massage paths and massage time corresponding to different massaged parts; the detection processing module is used for monitoring the usage state of the massage device and transmitting the fault information of the control device to a mobile terminal; and the communication module is used for enabling the massage device to communicate with the mobile terminal. An appropriate architecture mode is selected, such as MVC (Model-View-Controller) or MVVM (Model-View-View Model), to realize the hierarchical architecture of the system. An interaction mode between modules is designed to ensure that communication between the modules is clear, maintainable and extensible.

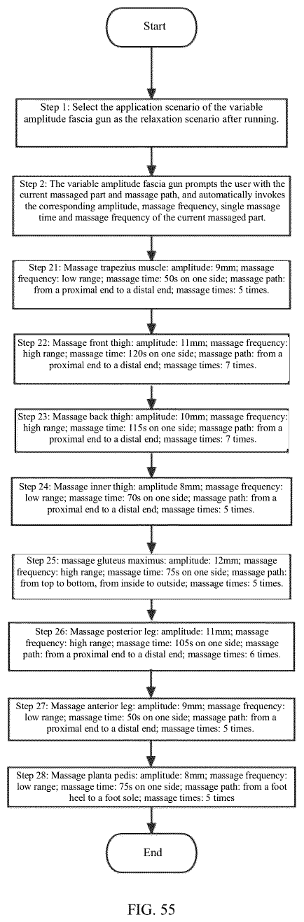

Compared with the sedentary office users mentioned above, after exercise, people need to massage and relax in completely different ways and massaged parts. FIG. 55 shows a control method based on a relaxation scenario after running. According to the muscle contraction and stretching state after running, the massage sequence of massaged parts and the massage amplitude of the variable amplitude fascia gun in each part are set. After running, the user directly selects the application scenario of the variable amplitude fascia gun, and relaxes the muscles according to the set massage sequence of the massaged parts and the massage amplitude of each part; compared with a way that the user selects the massage sequence and sets the amplitude of the variable amplitude fascia gun, the above way can greatly improve the massage effect of the user using the variable amplitude fascia gun for massage after running.

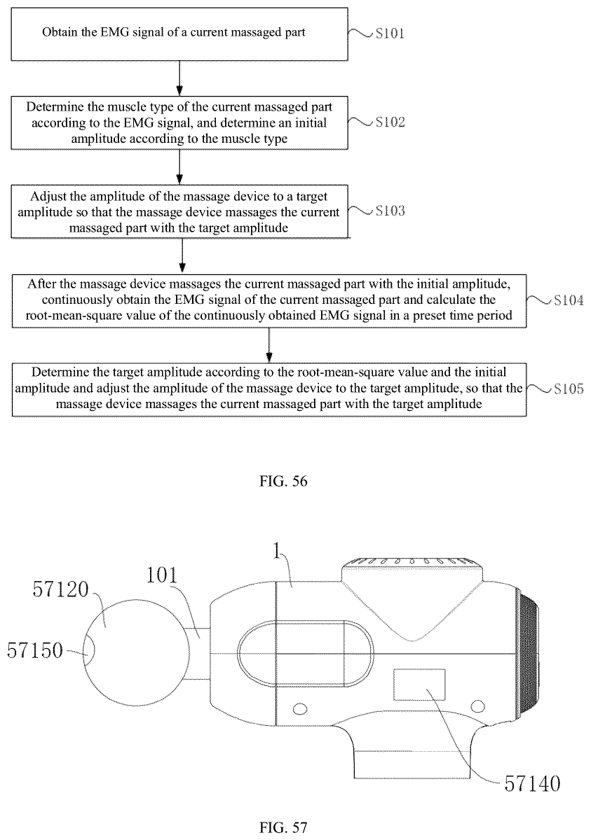

The specific muscle type can be determined by EMG signals, and the target amplitude can be obtained according to the muscle type. FIG. 56 shows an amplitude adjustment method based on the EMG signals. The muscle type of the current massaged part is determined according to the currently obtained EMG signals of the massaged part; the initial amplitude is determined according to the muscle type, and the amplitude of the massage device is adjusted to the initial amplitude, so that the massage device can massage the current massaged part at the initial amplitude. In other words, during the massage, the massage device automatically adjusts the amplitude according to the muscle type of the current massaged part, different types of muscles are massaged at different initial amplitudes, so that the initial amplitude is adapted to the human body part, and the purpose of improving the accuracy of amplitude adjustment is achieved.

In terms of muscle massage, the index of muscle oxygen saturation can indicate the fatigue degree of the muscles in hit parts. Smaller exercise intensity indicates higher muscle oxygen saturation. When less lactic acid is accumulated, the amplitude and the hitting depth can greatly increase, however, if the exercise intensity is higher, the muscle oxygen saturation is lower and the accumulated lactic acid is higher, so the initial hit of amplitude formation should be reduced, and then the amplitude increases to perform hitting after the muscle oxygen saturation increases, to improve the hitting depth. It can be seen that the hitting amplitude can be adjusted by taking the muscle oxygen saturation of the hit part as a reference. FIG. 57 shows an embodiment of amplitude adjustment based on muscle oxygen saturation. A physiological parameter collecting device 57150 is mounted on the massage head 57120, and the control system 57140 is electrically connected with the physiological parameter collecting device 57150 and the swing adjusting mechanism to control the swing adjusting mechanism according to the physiological parameters collected by the physiological parameter collecting device 57150, so as to adjust the position of the adjusting end of the adjusting rod 11 to change the amplitude of the piston 101 and finally adjust the amplitude of the massage head 120 connected with the piston 101. The physiological parameter collecting device 57150 collects the physiological parameters of the massaged part, and the massage head 57120 is in direct contact with the massaged part, so the physiological parameter collecting device 57150 is mounted on the massage head 57120. According to the position and massage function of the massaged part, the massage head 57120 is divided into a round head, a flat head, a U-shaped head, and the like; when the round head is used, the front end of the round head in a stretching direction is in contact with the massaged part, while other parts are not in contact with the massaged part; when the flat head is used, its flat end is in contact with the massaged part, and other parts are not in contact with the massaged part; when the U-shaped head is used, its two tips are in contact with the massaged part, and other parts are not in contact with the massaged part. It can be seen that when the massage head 57120 is used, it only partially contacts the massaged part, so the physiological parameter collecting device 57150 can be mounted on the surface of the massage head 57120 that contacts the massaged part, through such arrangement, the physiological parameter collecting device 57150 can directly contact the massaged part and acquire more accurate physiological parameters, thus making the amplitude adjustment more accurate and the usage effect more effective. After the massage head 57120 hits the massage part, because the massaged part is repeatedly hit by the massage head 57120, temperature will be generated at the massaged part. Specifically, the temperature will increase with the relaxation of the muscles in the massaged part. If the muscles are hard, the contact time will be short, the temperature will rise slowly, and the temperature will be low. In this case, hitting should be performed at the small amplitude to form the initial hit. However, with the relaxation of the muscles, the temperature rises rapidly and is higher, the amplitude should increase to increase the hitting depth, so as to implement the gradual massage process and achieve better massage effect. It can be seen that the hitting amplitude can be adjusted by taking the temperature value of the hit part as a reference. The physiological parameter collecting device 57150 includes a light source and a photosensitive sensor that are arranged at intervals, collected physiological parameters are the muscle oxygen saturation of the massaged part, the light source is used to emit light signals to the massaged part, and the photosensitive sensor receives light signals reflected from the massaged part, the control system 57140 is used to control the swing adjusting mechanism according to the muscle oxygen saturation, so as to adjust the position of the adjusting end of the adjusting rod 11 to change the amplitude of the massage head 57120.

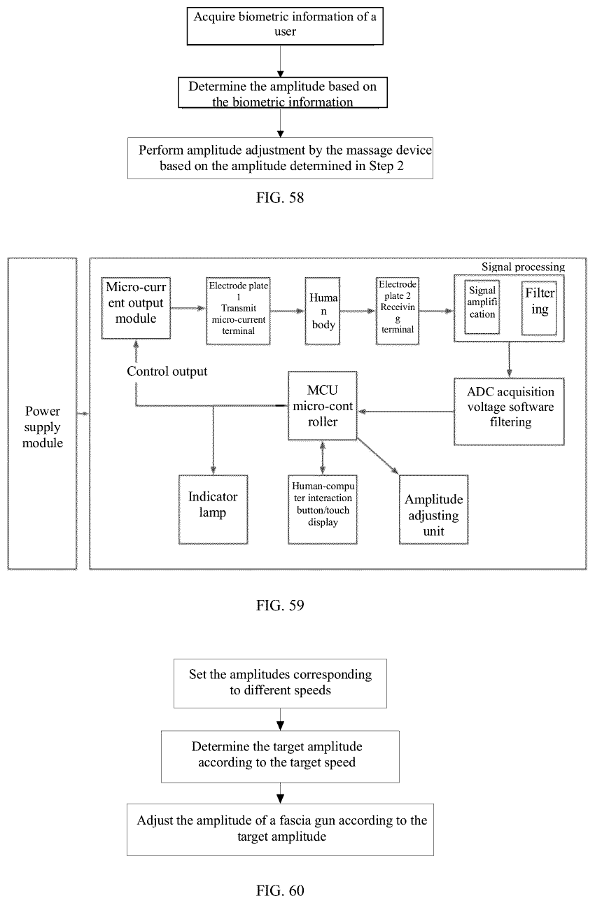

The sizes of muscle groups with different body fat and statures are different, and the massage effects at different amplitudes are also different. In actual use, if the amplitude of the massage device is recommended through biometric information, the amplitude can be more in line with the needs of users. The massage amplitude that is more suitable for the individual situation of the user can be obtained according to body fat and muscle groups. As shown in FIG. 58, a dynamic amplitude adjustment method based on biometric information is provided. When the amplitude is recommended, the amplitude range is gradually narrowed based on multiple parameters, and finally the output amplitude is determined. This can meet the massage needs of different people and effectively avoid muscle injury. The method includes the following steps: Step 1. Acquire biometric information of a user, where the biometric information at least includes body fat information; Step 2. Determine the amplitude based on the biometric information; and Step 3. Perform amplitude adjustment by the massage device based on the amplitude determined in Step 2. On this basis, the amplitude range can be gradually narrowed according to multiple biometric information in Step 2 to determine the final recommended amplitude, including: Step 21. Determine a maximum amplitude based on a first parameter; Step 22. Determine the amplitude range based on a second parameter; if the maximum amplitude determined based on the first parameter is less than a minimum amplitude determined based on the second parameter, a final amplitude is the maximum amplitude determined based on the first parameter; if not, proceed to a next step; Step 23. Reduce the amplitude range based on a third parameter; and Step 24. Determine a specific amplitude based on a fourth parameter, where first to fourth parameters are respectively one of gender, exercise amount, age and body fat information. The skin and muscle tissues of the elderly are relatively fragile. In order to avoid skin abrasion, muscle strain and even the impact on a cardiovascular system, the age is taken as the first parameter. According to the classification standard of the body fat, the body fat can be divided into four types: low, standard, high and excessively high; and a larger recommendation range can be determined according to the body fat, so body fat information is taken as the second parameter; due to gender differences, men are more suitable for larger amplitude, and women are suitable for smaller amplitude, so the gender is taken as the third parameter. The amplitude required for the recovery of a different exercise amount is also different, so the exercise amount is taken as the fourth parameter.

In addition, an appropriate amplitude can be automatically adapted to the user through body fat detection, this reduces the risk of damaging human muscles due to excessive amplitude and has better massage effect. Meanwhile, this also simplifies the operation difficulty of the user in amplitude selection and increases the user experience. FIG. 59 shows an embodiment of dynamic amplitude adjustment with body fat detection. The control unit is the MCU micro-controller, and a body fat detection unit includes two electrode plates for forming a current loop in the human body when contacting the human body, a detection component for detecting the current loop and a human-computer interaction unit for obtaining user information, where the detection component is used for detecting the current loop to obtain human body impedance. For the convenience of use, the two electrode plates are respectively arranged on both sides of the top of the fascia gun body. The massage object of the fascia gun can start to collect impedance after touching one electrode plate with both hands respectively. After impedance collection, the MCU controls the micro-current output module to output micro-current to the human body through the electrode plates and then transmit the micro-current from the human body through the electrode plates. Due to the poor conductivity of adipose tissues, they have a high degree of resistance to current, so the current will pass through conductive body fluids and muscles more easily. After the signal processing module amplifies and filters the voltage signals from the electrode plates, the MCU collects the signals through ADC, and the software filters the signal, when the resistance value is stable in a specified range for a period of time, and data is processed to obtain the voltage value; finally, through R=U/I (collected voltage/input current), the corresponding impedance of the human body can be obtained. In order to remind the user that the impedance is being acquired, an indicator lamp is also provided and electrically connected with the control unit, during the impedance acquisition, the control unit sends a working signal to the indicator lamp. A body fat detection function is attached to the fascia gun, and the body fat detection result can reflect the body fat content of users, thus helping the users to understand their own physical conditions.

Generally, low speed and high speed have different muscle stimulation effects at a same amplitude. The fascia gun can penetrate deep into muscle tissues and stimulate deep fascia at the low speed; and the fascia gun is more focused on relieving muscle soreness and promoting blood circulation at the high speed. However, the fascia gun at the high speed may damage the muscles. Therefore, when the fascia gun is used, the amplitude and the speed are adjusted reasonably according to the individual physical condition and needs. FIG. 60 shows an adjustment method that automatically matches different amplitudes for different speeds. Such an adjustment method simplifies the operation difficulty of the users, and the recommended amplitude is more in line with the needs of the users, which is conducive to improving the user experience. Different speeds match with different amplitudes, which reduces the risk of muscle injury caused by mismatched amplitudes or speeds. During the amplitude adjustment, two adjustment methods are provided, where slow adjustment can prevent the users from being uncomfortable due to the amplitude jump, and immediate adjustment can make the users feel the amplitude change exactly. The method for adaptively adjusting the amplitude of the fascia gun according to the speeds mainly includes three steps: Step 1. Set the amplitudes corresponding to different speeds; the following illustrates a specific adjustment solution of the low speed supporting the low amplitude and the high speed supporting the high amplitude; Step 2. Determine the target amplitude according to the target speed, where the target speed can be the current measured speed or the preset speed at the next moment; the measured speed can be counted by the number of pulses from the Hall sensor of the motor, and then the actual speed of the motor can be calculated. When the target speed is the measured speed, the speed is adjusted, and then the amplitude is adjusted. In this case, there is a certain lag in amplitude adjustment. When the target speed is the preset speed at the next moment, the speed and the amplitude can be synchronously adjusted. In this case, it is necessary to set the speed in advance, for example, a speed-time curve is used to obtain the speed at the next moment. Step 3. Adjust the amplitude of the fascia gun according to the target amplitude: the adjustment method can be an immediate adjustment method or a slow adjustment method, where the instant adjustment method is to directly jump the current amplitude into the target amplitude; and the slow adjustment method is to gradually adjust the amplitude to the target amplitude within a preset time. When the amplitude is adjusted by the slow adjustment method, the amplitude adjustment step size can be consistent, or it can be reduced and then increased or increased and then reduced according to the direction of amplitude jump to reduce the impact of amplitude jump on the users. Different speeds and different amplitudes can be used for different people and achieve different experience effects. After the hardware structure of the fascia gun is determined, the adjustment ranges of its speed and amplitude are also determined respectively. According to the changing directions of the speed and the amplitude, the speed and the amplitude can be adjusted in a same direction and a reverse direction within the adjustment ranges; the speed and the amplitude being adjusted in a same direction is that: the low speed supports the low amplitude, and the high speed supports the high amplitude. The speed and amplitude being adjusted in a reverse direction is that: the low speed supports the high amplitude, and the high speed supports the low amplitude. The adjustment method is applied to the fascia gun product, and the fascia gun includes a storage unit, configured to store a corresponding relationship between different speeds and corresponding amplitudes, where the corresponding relationship between the speeds and the amplitudes can be a speed-amplitude curve or a speed-amplitude table; a control unit, configured to determine the target amplitude by querying the storage unit according to the target speed, and to send the target amplitude to an adjusting unit; and the adjusting unit, configured to adjust the amplitude of the massage head of the fascia gun according to the target amplitude.

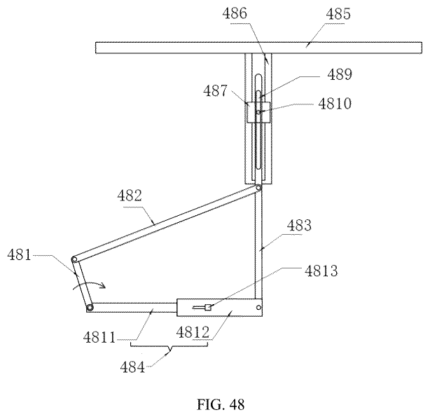

FIG. 48 is a structural schematic diagram showing an improvement in a massage effect through quick-return characteristics. The output module, the driving module for driving the output module to vibrate to realize massage, the adjusting module for adjusting the amplitude of the output module, and the housing where the output module, and the driving module and the adjusting module are mounted are provided; the driving module includes a crank rocker mechanism composed of a crank 481, a connecting rod 482 and a rocker 483 that are hinged in sequence, and ends of the crank 481 and the rocker 483 facing away from the connecting rod 482 are hinged at a fixed position, specifically, the driving module further includes a rack rod 484, a crank 481 and the rocker 483 facing away from the connecting rod 482 are hinged on the rack rod 484, the hinge positions of the crank 1 and the rocker 483 are limited by the rack rod 484, and the rocker 483 is driven to swing back and forth by the rotation of the crank 481. In actual design, the driving module further includes a driving motor for driving the crank 481 to rotate. The driving motor is fixed in the housing, and the output shaft of the driving motor and one end of the crank 481 facing away from the connecting rod 482 are fixed, the crank 481 is driven to rotate by the driving motor, so that the crank 481 rotates in a whole circle in relation to the rack rod 484. The output module includes a sliding rod 485 slidably arranged, a sliding rail 486 fixed at the center of the sliding rod 485, and a connecting block slidably connected into the sliding rail 486, the sliding direction of the connecting block is perpendicular to the sliding direction of the sliding rod 485, in the embodiment, the sliding direction of the sliding rod 485 is horizontal, and the sliding direction of the connecting block is vertical, an adjusting block 487 is hinged on the connecting block and mounted on the rocker 483, the rocker 483 drives the adjusting block 487 to swing back and forth, and the adjusting block 487 drives the connecting block to swing back and forth, while the sliding rail 486 restricts the connecting block from swinging, the connecting block can only slide vertically along the sliding rail 486 and rotate in relation to the adjusting block 487, meanwhile, the connecting block also moves laterally with the adjusting block 487, and then drives the sliding rod 485 to move laterally through the sliding rail 486, so that the sliding rod 485 can slide laterally back and forth. The output module includes a massage head extending out of the head of the housing, the massage head is fixedly connected with the sliding rod 485, and the sliding rod 485 drives the massage head to reciprocate when sliding laterally, so as to realize massage. In the structure, there is a direct correspondence between the rotation stroke of the eccentric wheel and the swinging angle of the output rod. In the design, the travel and return speeds of the slider can be controlled by limiting the size of the rod.

What is claimed is:

1. A reciprocating drive mechanism of continuously variable amplitude, comprising a slider-crank mechanism composed of a crank, an output rod, a connecting rod and a slider that are hinged in sequence, wherein comprising a swing adjusting mechanism, a hinge point between the output rod and the connecting rod is a swing hinge point, and the swing adjusting mechanism is configured to adjust and define the swinging range of the swing hinge point.

2. The reciprocating drive mechanism of continuously variable amplitude according to claim 1, wherein the swing adjusting mechanism comprises an adjusting rod with a swinging end and an adjusting end; the swinging end of the adjusting rod is hinged on the output rod, and the hinged position of the adjusting end of the adjusting rod is adjustable.

3. The reciprocating drive mechanism of continuously variable amplitude according to claim 2, wherein the crank is an eccentric wheel, the connecting rod is a swinging arm, and the slider is a piston, a connecting line between the rotating connecting end of the output rod and the swinging arm and the rotating input end of the eccentric wheel is a first cycloid, and a connecting line between the adjusting end of the adjusting rod and the rotating input end of the eccentric wheel is a second cycloid; an included angle between the first cycloid and the reciprocating axis of the piston is a first included angle θ, and an included angle between the second cycloid and the reciprocating axis of the piston is a second included angle β; and the second included angle β is adjusted so that the swinging range of the first included angle θ is adjusted in linkage.

4. The reciprocating drive mechanism of continuously variable amplitude according to claim 3, wherein the reciprocating amplitude of the piston satisfies the following relationship: F=L1*|Cos θmax−Cos θmin|; wherein F represents the reciprocating amplitude of the piston; L1 represents the length of the first cycloid, θmax represents the maximum swing angle of the first cycloid with respect to the second included angle β; and θmin represents the minimum swing angle of the first cycloid with respect to the second included angle β.

5. The reciprocating drive mechanism of continuously variable amplitude according to claim 4, wherein the second included angle β ranges from −20° to 30°, and the swing angle of the first included angle θ ranges from −20° to 90°.

6. The reciprocating drive mechanism of continuously variable amplitude according to claim 3, comprising an output hinge point between the output rod and the crank, an adjusting hinge point between the output rod and the swinging end of the adjusting rod, and a projection plane perpendicular to the rotating input end of the eccentric wheel, wherein the output hinge point, the adjusting hinge point and the swing hinge point are all projected onto the projection plane to obtain corresponding projection points, and the included angle of the connecting lines between any two projection points ranges from 0° to 360°.

7. The reciprocating drive mechanism of continuously variable amplitude according to claim 2, further comprising a position adjusting mechanism, wherein the adjusting end of the adjusting rod is hinged on the position adjusting mechanism, and the position adjusting mechanism drives the adjusting end of the adjusting rod to move in relation to a position.

8. The reciprocating drive mechanism of continuously variable amplitude according to claim 7, wherein the position adjusting mechanism comprises a lead screw and a lead screw nut, and the lead screw nut is rotatably arranged on the adjusting end of the adjusting rod, the lead screw is connected with a driving unit, and the driving unit drives the lead screw to rotate, whereby driving the lead screw nut to axially slide along the lead screw.

9. The reciprocating drive mechanism of continuously variable amplitude according to claim 8, wherein the driving unit is a driving motor or a manual knob.

10. The reciprocating drive mechanism of continuously variable amplitude according to claim 7, wherein the position adjusting mechanism is a limit chute, the adjusting end of the adjusting rod is hinged with a slider slidably arranged in the limit chute, a slider fixing mechanism for fixing the slider to the limit chute is arranged on the slider, the slider fixing mechanism is a threaded knob and a fastening block in threaded fit with the threaded knob, and the slider is fixedly arranged on the limit chute when the threaded knob is tightened.

11. The reciprocating drive mechanism of continuously variable amplitude according to claim 1, wherein the swing adjusting mechanism comprises a limit baffle, the swinging range of the swing hinge point is set within the swinging range of the limit baffle, and the swinging range of the limit baffle is adjustable.

12. The reciprocating drive mechanism of continuously variable amplitude according to claim 11, wherein the limit baffle has two baffles, the swing hinge point is arranged between the two baffles, and the distance between the two baffles is adjustable.

13. A fascia gun, comprising:
a mounting chamber including a lower shell, an upper shell, a front cover, a rear cover, and a motor for driving a crank to rotate;
a reciprocating drive mechanism of continuously variable amplitude, wherein the reciprocating drive mechanism of continuously variable amplitude comprises a slider-crank mechanism composed of a crank, an output rod, a connecting rod and a slider that are hinged in sequence, comprises a swing adjusting mechanism, wherein a hinge point between the output rod and the connecting rod is a swing hinge point, and the swing adjusting mechanism is configured to adjust and define the swinging range of the swing hinge point;
the swing adjusting mechanism comprises an adjusting rod with a swinging end and an adjusting end; the swinging end of the adjusting rod is hinged on the output rod, and the hinged position of the adjusting end of the adjusting rod is adjustable; and
a position adjusting mechanism, wherein the adjusting end of the adjusting rod is hinged on the position adjusting mechanism, and the position adjusting mechanism drives the adjusting end of the adjusting rod to move in relation to a position.

14. The fascia gun according to claim 13, wherein the position adjusting mechanism is a limit chute, the adjusting end of the adjusting rod is hinged with a slider slidably arranged in the limit chute, a slider fixing mechanism for fixing the slider to the limit chute is arranged on the slider, the slider fixing mechanism is a threaded knob and a fastening block in threaded fit with the threaded knob, and the slider is fixedly arranged on the limit chute when the threaded knob is tightened; and
the slider is a piston slidably arranged in the piston hole of the front cover, the crank is an eccentric wheel, and the rotating input end of the eccentric wheel is fixedly connected with the output shaft of the motor.

15. The fascia gun according to claim 14, further comprising a motor fixing stand, and the motor and the swing adjusting mechanism are arranged on the motor fixing stand.

16. A fascia gun, comprising:
a mounting chamber including a lower shell, an upper shell, a front cover, a rear cover, and a motor for driving a crank to rotate;
a reciprocating drive mechanism of continuously variable amplitude, wherein the reciprocating drive mechanism of continuously variable amplitude comprises a slider-crank mechanism composed of a crank, an output rod, a connecting rod and a slider that are hinged in sequence, comprises a swing adjusting mechanism, wherein a hinge point between the output rod and the connecting rod is a swing hinge point, and the swing adjusting mechanism is configured to adjust and define the swinging range of the swing hinge point;
the swing adjusting mechanism comprises a limit baffle, the swinging range of the swing hinge point is set within the swinging range of the limit baffle, and the swinging range of the limit baffle is adjustable; and the limit baffle has two baffles, the swing hinge point is arranged between the two baffles, and the distance between the two baffles is adjustable; and
the slider is a piston slidably arranged in the piston hole of the front cover, the crank is an eccentric wheel, and the rotating input end of the eccentric wheel is fixedly connected with the output shaft of the motor.
